(19) United States
(12) Patent Application Publication
(10) Pub. No.: US 2013/0262980 A1
(43) Pub. Date: Oct. 3, 2013

(54) INFORMATION PROCESSING APPARATUS, HISTORY CONTROL METHOD, AND COMPUTER-READABLE RECORDING MEDIUM

(71) Applicant: FUJITSU LIMITED, Kawasaki-shi (JP)

(72) Inventor: Masashi UYAMA, Kako (JP)

(21) Appl. No.: 13/716,518

(22) Filed: Dec. 17, 2012

(30) Foreign Application Priority Data
Mar. 30, 2012 (JP) 2012-083278

(51) Int. Cl. G06F 17/22

(52) U.S. Cl. CPC G06F 17/2247
USPC 715/234

(57) ABSTRACT

An information processing apparatus includes a memory that stores a display history of a page displayed on a display unit for individual sequences. The information processing apparatus turns a page in which a page displayed on the display unit is switched to a page stored in the memory and displays the switched page on the display unit. The information processing apparatus switches a sequence of the page displayed on the display unit and displays a switched page on the display unit. The information processing apparatus holds a switched second page when a sequence of a first page displayed on the display unit is switched. The information processing apparatus stores the second page held in the memory as a display history corresponding to the sequence of the first page, when a sequence is switched on the second page, or on a third page after switched from the second page.

### CROSS-REFERENCE TO RELATED APPLICATION

This application is based upon and claims the benefit of priority of the prior Japanese Patent Application No. 2012-083278, filed on Mar. 30, 2012, the entire contents of which are incorporated herein by reference.

### FIELD

The embodiments discussed herein are related to an information processing apparatus, a history control method, and a computer-readable recording medium.

### BACKGROUND

In a case of browsing data having a hyperlink structure like the World Wide Web, a user can decide to display which page will be displayed next while browsing a certain Web page. It is difficult to uniquely determine a page to be displayed as “a subsequent page” until the user selects a hyperlink. A manipulation to select and display a page to be displayed next is referred to as a subsequent page select manipulation.

The subsequent page select manipulation is repeated to display one page after another. Many web browsers include schemes to manage the histories of pages displayed in the past, and include a page turning manipulation to browse display histories. The page turning manipulation is implemented by pressing down a button, or by flicking a touch panel, for example.

The subsequent page select manipulation is used for the last page of a display history and also used for a case where pages are turned to go back a display history in the past and a branch is made to a new page on the page in the midway point of the history. Many web browsers can browse display histories in the past as well as can follow another hyperlink from the pages displayed in the past. Moreover, data of input items described in a form on a displayed page is changed to make a branch to a new page on the page in the midway point of a history. For example, in a case where the simulation of life insurance is made on the web, it can be considered that the acceptance of input to a Web form and the result of the input are repeatedly displayed to correct an insurance plan.

As described above, when repeating a subsequent page select manipulation, browsing a display history in the past by a page turning manipulation, and making a branch on the page in the midway point of the display history by a subsequent page select manipulation, a display history in a tree structure is generated. For example, when a subsequent page select manipulation is repeated for three times from a page P1, a display history including pages P1, P2, P3, and P4 is generated. Suppose that the page P4 is turned to go back the history to the pages P3, P2, and P1, a branch is made on the page P1 to a page P5 again by a subsequent page select manipulation, pages P6, P7, and P8 are displayed from the page P5 by subsequent page select manipulations, a page P8 is turned to go back the history to the pages P7 and P6, a branch is made on the page P6 to a page P9 again by a subsequent page select manipulation, and a subsequent page select manipulation is made on the page P9 to display a page P10. In this case, such a tree structure is generated in which the pages P1 and P6 are branch nodes.

In order to manipulate a display history in a tree structure generated by repeating subsequent page select manipulations and page turning manipulations as decried above with page turning manipulations, the tree structure correspond to a one-dimensional page sequence is made. For a method for managing a display history with correspondence like this, such methods are known as “Temporal Sequence”, “Stack Model”, and “Temporal with duplicates”. These methods are known as display history management for web browsers.

“Temporal Sequence” is a method for managing pages displayed on a window in a temporal order including a case of displaying a history. For example, in a case where the user repeats subsequent page select manipulations and page turning manipulations to browse pages in order of pages P1, P2, P3, P4, P3, P2, P1, P5, P6, P7, P8, P7, P6, P9, and P10, the history of the pages is managed as it is. “Stack Model” is a method for managing only the latest branches as a display history like the pages P1, P5, P6, P9, and P10. “Temporal with duplicates” is a method in which pages that appear for a plurality of times in a “Temporal Sequence” like pages P1, P2, P3, P4, P1, P5, P6, P7, P8, P6, P9, and P10 are omitted from a history after the pages appear for a second time in principle, but pages are recorded on the history in a case where the pages are the starting points of branches in subsequent page select manipulations as exceptions.
Non-Patent Document 1: Natasa Milic-Frayling, Rachel Jones, Kerry Rodden, Gavin Smyth, Alan Blackwell, Ralph Sommerer, “SmartBack: Supporting Users in Back Navigation” ACM WWW 2004, p. 64.

However, the page turning manipulation is a manipulation that can be used not only for browsing display histories but also for browsing various items of data of one-dimensional temporal sequences. In small-sized terminals becoming popular in these years such as a smart phone, the page turning manipulation is often used. For data of one-dimensional temporal sequences that can be manipulated by turning pages, there are a sequence of E-mails received from Mr. A, a workflow in association with ordering to Company B, the history of jobs at the specific Site C, the history of services offered to Client D, and the list of slips that approval is requested, for example. Generally, a user frequently switches tasks or page sequences because of external interrupts for tasks or recalling a task related to a page that the user is seeing. Namely, branching of a task occurs. There is a problem in that it is difficult to appropriately manage display histories when conventional techniques are applied to a terminal using the page turning manipulation.

For example, in “Temporal Sequence”, since displayed pages are registered in a history for the number of times at which displayed pages are displayed, the number of manipulations is increased in making reference to the history in the past by turning pages, and the method is inefficient. Moreover, in “Stack Model”, since pages that are branches in the midway point are not registered as a history, no reference is made to these pages by turning pages.

Furthermore, it can be said that “Temporal with duplicates” is a method in which a page appearing in a web reference path for the first time is recorded on a history and in a case where the same page appears for the second time or more is not recorded. However, in a case where a page is a branch point at which the user selects a subsequent page, the page is recorded as an exception. In this method, page groups in the midway point until the user follows a page sequence by turning pages and reaches an object page are also stored in a history, so that the method is not always efficient.

In addition, “Temporal with duplicates” can also be implemented as a concept that pages on which the user performs actions other than turning pages are recorded in a history. Since pages at which the user can visit again by turning pages are not stored in a history in this mounting, the history is shortened, and only pages on which the user performs explicit manipulations and which the user remembers are left in the history, so that the method is highly convenient. However, since all the branch points in a sequence are stored, sequences to which just a reference is made with no intention are also redundantly stored in the history, and manipulations in making a reference to the history in the past by turning pages are not always convenient.

As described above, in the conventional methods for managing the histories of web browsers, it is difficult to appropriately manage display histories including branches. A display history including switching sequences includes redundant information, and it is difficult to efficiently browse display histories including branches by turning pages.

### SUMMARY

According to an aspect of the embodiment, an information processing apparatus includes: a memory that stores a display history of a page displayed on a display unit for individual sequences; and a processor coupled to the memory, wherein the processor executes a process comprising: executing page turning in which a page displayed on the display unit is switched to a page stored in the memory and displaying the switched page on the display unit; switching a sequence of the page displayed on the display unit and displaying a switched page on the display unit; holding a switched second page when a sequence of a first page displayed on the display unit is switched; and storing the held second page in the memory as a display history corresponding to the sequence of the first page, when a sequence of the second page or a sequence of a third page after switched from the second page is switched at the switching.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of the configuration of an information processing apparatus according to a first embodiment;

FIG. 2 is a diagram of exemplary information stored in a performer task schedule;

FIG. 3 is a diagram of exemplary information stored in a page class transition rule table;

FIG. 4 is a diagram illustrating the relationship between tasks and pages;

FIG. 5 is a diagram of exemplary items stored in a task management table;

FIG. 6 is a diagram of exemplary items stored in the entries of a page attribution table;

FIG. 7 is a diagram illustrative of path types;

FIG. 8 is a diagram of exemplary items stored in the entries of a sequence management table;

FIG. 9 is a diagram of exemplary items stored in the entries of a viewpoint sequence definition table;

FIG. 10 is a diagram of exemplary criteria for adding a page in a display history when switching a sequence;

FIG. 11 is a flowchart of a flow of a page turning process;

FIG. 12 is a flowchart of a flow of a sequence switching process;

FIG. 13 is a flowchart of a flow of a sequence switching history process;

FIG. 14 is a flowchart of a flow of a display history adding subprocess;

FIG. 15 is a diagram of a first specific example when switching a sequence;

FIG. 16 is a diagram of a second specific example when switching a sequence;

FIG. 17 is a diagram of a third specific example when switching a sequence;

FIG. 18 is a diagram of a fourth specific example when switching a sequence;

FIG. 19 is a diagram of exemplary criteria for adding a page in a display history when selecting a subsequent page;

FIG. 20 is a flowchart of a flow of a subsequent page select process;

FIG. 21 is a flowchart of a flow of a subsequent page transition process;

FIG. 22 is a flowchart of a flow of a subsequent page select history process;

FIG. 23 is a diagram of a first specific example when selecting a subsequent page;

FIG. 24 is a diagram of a second specific example when selecting a subsequent page;

FIG. 25 is a diagram of a third specific example when selecting a subsequent page;

FIG. 26 is a diagram of a fourth specific example when selecting a subsequent page;

FIG. 27 is a diagram of a fifth specific example when selecting a subsequent page;

FIG. 28 is a diagram of a sixth specific example when selecting a subsequent page; and

FIG. 29 is a diagram of an exemplary hardware configuration of an information processing apparatus.

### DESCRIPTION OF EMBODIMENTS

Preferred embodiments will be explained with reference to accompanying drawings.

It is noted that the present invention is not limited by the embodiments.

### [a] First Embodiment

### Overall Configuration

An information processing apparatus to be disclosed is an apparatus such as a smart phone and a personal computer, for example. In this information processing apparatus, a page on which various items of information are described is displayed on a display, and the displayed page is stored as a history. In such an information processing apparatus, a user who uses the apparatus sometimes searches for a page in the past from a history.

In this case, the user turns pages to again display a page displayed in the past, switches between page sequences, or further turns pages on the page on which the sequence is switched. In other words, in a case where the user searches for a desired page in the past from a page presently displayed, the user rarely reaches the desired page in a simple way, but the user reaches the desired page through making a plurality of branches.

For example, the user sometimes turns pages as follows. The user switches the sequence of a page 1, turns pages, and displays a plurality of pages. The user returns to the original page 1 after switched, switches to another sequence to display a page 3, and then turns pages from the page 3.

In this case, the information processing apparatus usually holds a series of pages displayed until the user searches for and reaches a desired page as a new history. However, this series of pages is a history of the user's search simply stored as described above, and includes a lot of useless information. Consequently, even though the information processing apparatus displays the series of pages through turning pages in a case where the user again searches for the same page, it is not said that the process is a useful search process, and the process takes time.

Therefore, the information processing apparatus to be disclosed handles three types of sequences in a time series: a display history sequence in a case where the user uses a terminal in a time series, a task sequence that follows the flow of jobs, and a viewpoint sequence that stores the results of searching a database from various viewpoints in a time series.

This information processing apparatus stores the display history of pages displayed on a display for individual sequences. The information processing apparatus then holds a switched second page in a case where the sequence of the first page displayed on the display is switched. After that, the information processing apparatus stores the holding second page as a display history corresponding to the sequence of the first page in a case where the sequence is switched on the second page, or the sequence is switched on the third page after switching the sequence from the second page.

In other words, in a case where the user switches between pages, the information processing apparatus to be disclosed temporarily holds the switched page as a history candidate, and holds the page of the history candidate as a history when pages are further switched. With this configuration, the information processing apparatus to be disclosed can hold the branches of pages, for which the user searches, as a history. As a result, the information processing apparatus to be disclosed can appropriately manage display histories including branches. Moreover, the information processing apparatus to be disclosed can extract useful pages among displayed pages in searching for a desired page by the user and hold the pages as a history, so that the apparatus can perform a useful search process even in a case where the user again searches for the same page. Furthermore, the user can perform efficient history searches, and can browse pages by turning pages regardless of the types of sequences of interest.

Functional Block Diagram

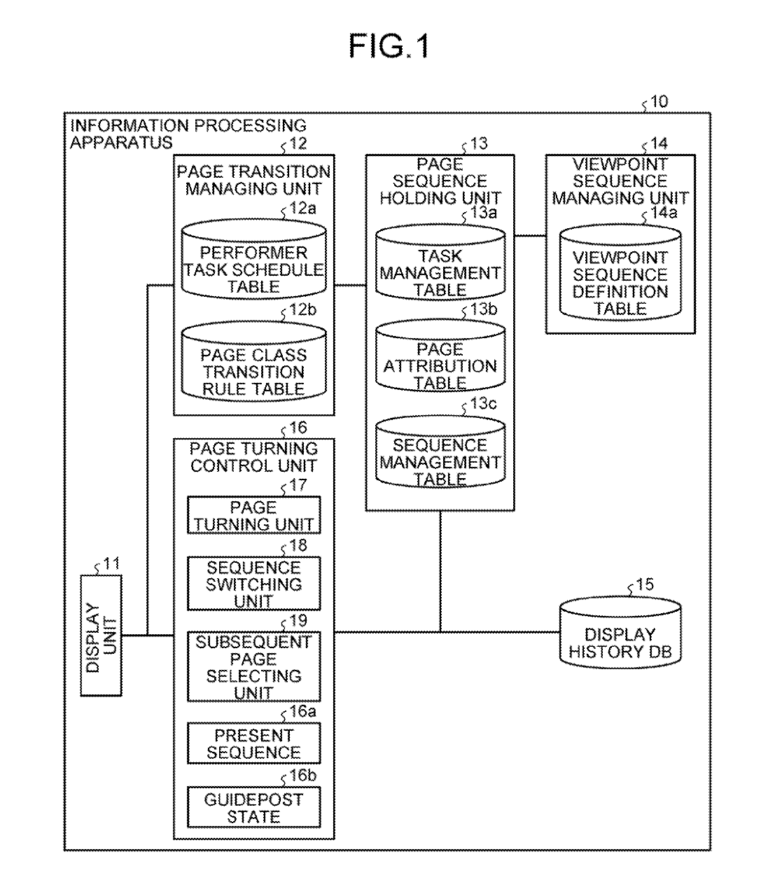

FIG. 1 is a functional block diagram of the configuration of an information processing apparatus according to a first embodiment. As illustrated in FIG. 1, an information processing apparatus 10 includes a display unit 11, a page transition managing unit 12, a page sequence holding unit 13, a viewpoint sequence managing unit 14, a display history DB 15, and a page turning control unit 16. It is noted that the processing units represented here are merely examples, and the embodiment is not limited thereto. The processing units may include other processing units such as an input unit, for example. It is noted that the processing units are processing units run by a processor, and tables and the DB are provided in a storage device such as a memory.

The display unit 11 is a display unit that displays pages, and is a touch panel, for example. The display unit 11 accepts various manipulations on a displayed page. For example, the display unit 11 can determine whether a manipulation is to turn a page, switch a sequence, or select a subsequent page from display content and a finger motion or the like on the touch panel. The display unit 11 then outputs the content of the accepted manipulation to the page turning control unit 16.

The page transition managing unit 12 is a processing unit that includes a performer task schedule table 12a and a page class transition rule table 12b, and manages the transition between pages and between tasks. This page transition managing unit 12 uses the performer task schedule table 12a and the page class transition rule table 12b in determining a subsequent page that is a transition destination. Moreover, the page transition managing unit 12 updates a task management table to manage.

It is noted that in a device with a narrow screen like a smart phone, a mainstream concept is that the entire display is considered as one window and applications are switched in the window. When the user uses a smart phone to do a task, the page transition managing unit 12 decomposes the task into subtasks, generates pages for individual subtasks, and in turn transitions from one page to another according to button manipulations on the displayed page.

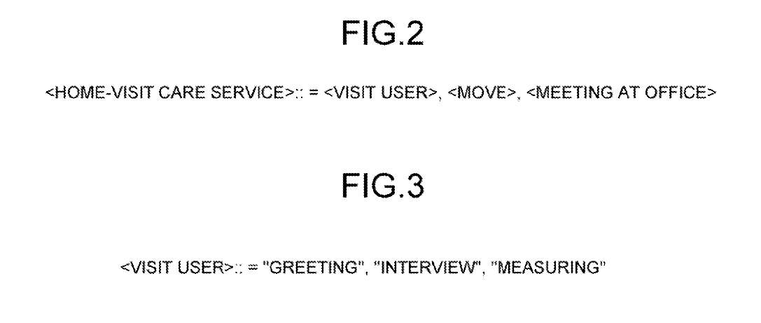

The performer task schedule table 12a is a table that manages the task schedule of the user. FIG. 2 is a diagram of exemplary information stored in the performer task schedule. As illustrated in FIG. 2, the performer task schedule table stores “<home-visiting care service>::=<visit a user>, <move>, <meeting at office>”. In other words, a process called a home-visiting care service indicates that tasks are performed in order of visit a user, move, and a meeting at office.

The page class transition rule table 12b is a table that stores transition rules for pages. FIG. 3 is a diagram of exemplary information stored in the page class transition rule table. As illustrated in FIG. 3, the page class transition rule table 12b stores “<visit a user>:: =“greeting”, “interview”, “measuring”, and so on”. In other words, the task “visit a user” includes the subtasks of greeting, interview, and measuring.

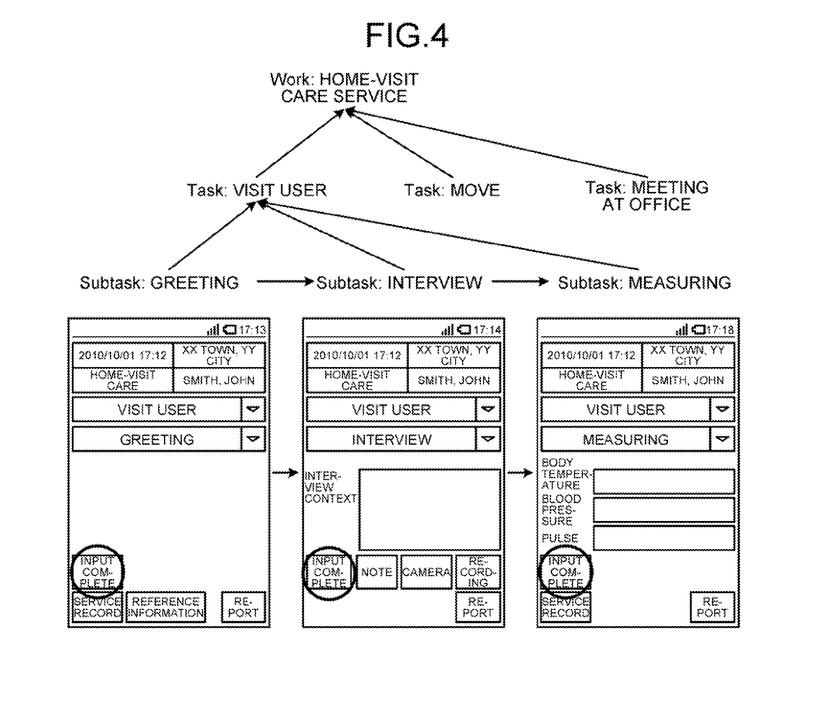

Here, the relationship between tasks and pages will be described. FIG. 4 is a diagram illustrative of the relationship between tasks and pages. As illustrated in FIG. 4, the work “home-visiting care service” performs tasks of “visit a user”, “move”, and “meeting at office”. Here, when the task “visit a user” is taken as an example and described, the task “visit a user” performs subtasks “greeting”, “interview”, and “measuring”. A page to be displayed is generated on a screen for individual subtasks, and pages are in turn transitioned by manipulating a button on a page. For example, the user clicks an “input complete” button on a page “greeting” displayed on the display unit 11, and then the page can be transitioned to a page of “interview”.

The page sequence holding unit 13 is a processing unit that includes a task management table 13a, a page attribution table 13b, and a sequence management table 13c, and manages pages, sequences, and tasks. This page sequence holding unit 13 manages information that identifies that which page belongs to which task and which page belongs to which sequence.

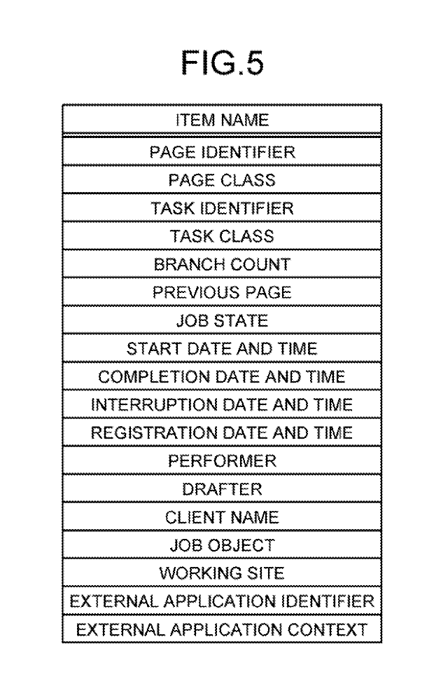

The task management table 13a is a table that manages information about tasks. In the task management table 13a, data entries are described for individual pages identified by page identifiers. A new item of data is added every time when a new page is generated. FIG. 5 is a diagram of exemplary items stored in the entries of the task management table.

As illustrated in FIG. 5, the task management table 13a stores “a page identifier, a page class, a task identifier, a task class, a branch count, a previous page, and a job state”. Moreover, the task management table 13a stores “a start date and time, a completion date and time, an interruption date and time, a registration date and time, a performer, a drafter, and a client name”. Furthermore, the task management table 13a stores “a job object, a working site, an external application identifier, and an external application context”.

“The page identifier” is an identifier that uniquely identifies a page, and “the page class” is information used by the page transition managing unit 12, representing the class of the page. As discussed above, since pages to be displayed are generated on the screen for individual subtasks, the page class is information such as “greeting” and “interview” in exemplary information stored in the page class transition rule table in FIG. 3, for example. “The task identifier” is an identifier of a task that includes an appropriate page. “The task class” is information used by the page transition managing unit 12, representing the class of a task. <Visit a user> in exemplary information stored in the page class transition rule table in FIG. 3 corresponds to the task class, for example. “The branch count” indicates the number of flows branched from a relevant page, and is used when the page transition managing unit 12 generates a new sequence identifier. “The previous page” indicates a page before transitioning to a relevant page. “The job state” indicates the execution state of a page, to which events that the job is not started, the job is started, the job is interrupted, the job is completed, and the job is corrected are set, for example. The job state is updated by the page transition managing unit 12. “The start date and time” is a date and time at which the job on the page is started. “The completion date and time” is a date and time at which the job on the page is completed. “The interruption date and time” is a date and time at which the job is interrupted, not completed.

“The registration date and time” is a date and time at which an entry is made on the table of the relevant page. “The performer” indicates the performer of a job on the page. “The drafter” indicates the drafter of the job on the page. “The client name” indicates the client of the job on the page. “The job object” indicates the job object of the page. “The working site” indicates a place where the job on the page is performed. Moreover, “the external application identifier” indicates an application that generates the page. “The external application context” is items of information used for running the application. Among three types of the sequences handled in the information processing apparatus to be disclosed, the task sequence corresponds to a sequence of tasks that the task management table is searched for entries having the same task identifiers and the entries are sorted in a time series. The viewpoint sequence corresponds to a sequence of tasks that the task management table is searched by conditional expressions formed of the working site, the client name, and so on and the tasks are sorted in a time series.

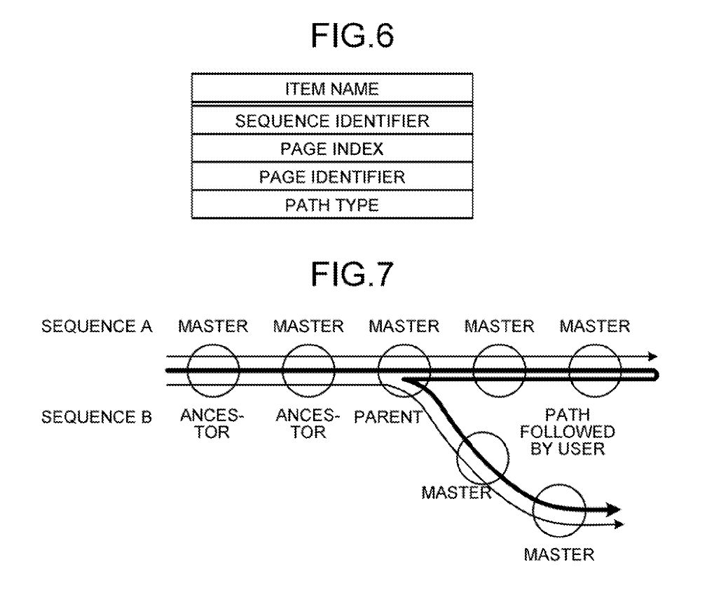

The page attribution table 13b is a table that stores information identifying to which sequences pages belong. FIG. 6 is a diagram of exemplary items stored in the entries of the page attribution table. More specifically, as illustrated in FIG. 6, the page attribution table 13b stores “a sequence identifier, a page index, a page identifier, and a path type”.

“The sequence identifier” is an identifier of a sequence, and expressed by three integer values. For example, in a case of the display history sequence, the identifier is expressed by {0, 0, 0}. In a case of the viewpoint sequence, the identifier is expressed by {0, a conditional expression serial number, 0}, where the conditional expression serial number is expressed by an integer of one or more. Moreover, in a case of the task sequence, the identifier is expressed by {a task ID, a branched page ID, a branch ID}, where the task ID is expressed by an integer of one or more. “The page index” is a serial number that represents a position in a sequence, and is an integer started from one. “The page identifier” is an identifier of a page located in the index of a relevant sequence. “The path type” represents the form belonging to a relevant page sequence in the task sequence, and any one of a master, a parent, and an ancestor is set, for example.

Here, the path type will be described. FIG. 7 is a diagram illustrative of path types. As illustrated in FIG. 7, in a sequence A that originally exists, pages are handled as “a master”. In a sequence B that is newly branched in the midway point of the sequence A, pages after branched are distinguished as “a master”, a page on which a branch is made as “a parent”, and a page group before making a branch as “an ancestor”. The path type is used in narrowing search results only to a sequence that the path type is “the master”, in searching the page attribution table 13b for a set of a sequence to which the present page belongs and an index in the sequence by the information processing apparatus 10 according to a sequence switching process. A sequence that the path type is “the master” on the pages in the page attribution table is referred to as a master task sequence.

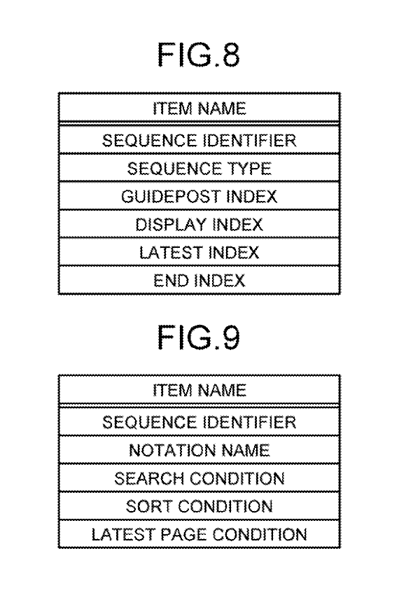

The sequence management table 13c is a table that manages page sequences. FIG. 8 is a diagram of exemplary items stored in the entries of the sequence management table. More specifically, as illustrated in FIG. 8, the sequence management table 13c stores “a sequence identifier, a sequence type, a guidepost index, a display index, a latest index, and an end index”.

“The sequence identifier” is a set of three integer values as described above. “The sequence type” represents a distinction between the task sequence, the viewpoint sequence, and the display history sequence, and any one of the task, the viewpoint, or the display is set. It is noted that the viewpoint sequence and the task sequence are combined and integrally referred to as a general sequence. “The guidepost index” is an index that represents a page to be recorded as a display history in the general sequence. The page is the page that is first displayed after selecting the sequence, or the page that is newly generated in the sequence.

“The display index” represents that the i-th page in a relevant sequence is presently selected on the window. When the sequence is a present sequence, the page indicated by the display index is presently displayed. “The latest index” is an index that represents the page recently manipulated by the user in the sequence. “The end index” is an index that indicates the last page of the sequence. Since a sequence may also include pages that express a task schedule in the future, the latest index is not always the end index. In the embodiment, the indexes of a sequence take integer values ranging from one to the value of the end index.

The viewpoint sequence managing unit 14 is a processing unit that includes a viewpoint sequence definition table 14a. The viewpoint sequence definition table 14a is a table that stores the conditions of searching the task management table 13a, for example. FIG. 9 is a diagram of exemplary items stored in the entries of the viewpoint sequence definition table. More specifically, as illustrated in FIG. 9, the viewpoint sequence definition table 14a stores “a sequence identifier, a notation name, a search condition, a sort condition, and a latest page condition”.

“The sequence identifier” is an identifier that identifies the viewpoint sequence. “The notation name” indicates a name when the name is presented to the user. “The search condition” indicates the condition of searching the task management table 13a. “The sort condition” indicates the sorting condition in a time series. “The latest page condition” indicates the condition of determining the latest index in the sequence.

The display history DB 15 is a storage unit that stores the display histories of pages. The processing units represented here are only examples, and the embodiment is not limited thereto. For example, the display history DB 15 may be an independent storage unit, or may be a storage unit that is changed in association with the results of extracting a display history sequence from the page attribution table 13b.

The page turning control unit 16 manages a present sequence 16a and a guidepost state 16b, and performs a page turning process, a sequence switching process, and a subsequent page select process. It is noted that the present sequence 16a and the guidepost state 16b will be described here because each process will be described later.

The present sequence 16a is an identifier that uniquely identifies a sequence which is an object for turning pages currently. The identifier that uniquely identifies a sequence is synonymous with the sequence identifier described above, which is expressed by a set of three integer values. The guidepost state 16b takes a value of “temporary” or “fixed”, and represents the state of a page indicated by the guidepost index of the present sequence 16a. When the page is already added to the tail of the display history, the state is “fixed”, whereas in a case where the page is not added but possibly added, the state is “temporary”.

Processing Content of the Processing Units

Next, the processing content performed by the processing units illustrated in FIG. 1 will be described more in detail. Here, processes performed by the page transition managing unit 12, the page sequence holding unit 13, the viewpoint sequence managing unit 14, and the page turning control unit 16 with reference to the tables or the like will be described more in detail.

The page transition managing unit 12 determines one page from a plurality of pages that can be transitioned from the present page to the subsequent page according to a present sequence and a user manipulation to the present page indicated by the display index of the present sequence. The page transition managing unit 12 then returns a subsequent page identifier that identifies the page, a subsequent sequence identifier that represents a page turning object sequence in displaying the subsequent page, and an update index that indicates the index in the subsequent sequence of the present page. Moreover, in a case where there is no subsequent page that can be displayed in generating the page to be displayed next according to a user manipulation to the present page, the page transition managing unit 12 determines that the subsequent page identifier is undetermined and that the subsequent sequence identifier is the identifier of the present sequence.

For example, in a case where the present sequence is a task sequence and the present page is the page indicated by the latest index of the task sequence, the page transition managing unit 12 determines the present sequence as a subsequent sequence identifier. Moreover, in a case where the present sequence is a task sequence and the present page is not the page indicated by the latest index of the task sequence, the page transition managing unit 12 generates a new sequence identifier, determines the new sequence identifier as a subsequent sequence identifier, and determines the subsequent sequence identifier as the master task sequence of the subsequent page.

Furthermore, in a case where the present sequence 16a is a viewpoint sequence, and in a case where the present page is the page indicated by the latest index of the master task sequence of the present page, the page transition managing unit 12 determines the master task sequence as a subsequent sequence identifier. In addition, in a case where the present sequence is a viewpoint sequence, and in a case where the present page is not the page indicated by the latest index of the master task sequence of the present page, the page transition managing unit 12 generates a new sequence identifier, and determines the new sequence identifier as a subsequent sequence identifier. Moreover, the page transition managing unit 12 determines the subsequent sequence identifier as the master task sequence of the subsequent page.

In page transition, since a subsequent page is generated according to the flow of the task sequence, to which the present page belongs, a change in the present sequence 16a may be sometimes accompanied. For example, in the case where the present sequence 16a is a viewpoint sequence, a page newly generated has a viewpoint different from the present sequence 16a, so that the present sequence 16a is switched to the task sequence of the corresponding page. Moreover, the subsequent page information is not sometimes returned depending on the content of a task. For example, suppose that the case is considered that a task needs an approval of the director of a department and then an approval of the manager of an office. After the director of the department gives approval on the page for the approval of the director of the department, the page for the approval of the manager of the office, which is the subsequent page, is not presented to the director of the department on the task. Therefore, the page transition managing unit 12 determines that the subsequent page identifier is undetermined because there is no subsequent page that can be displayed.

The page sequence holding unit 13 holds a plurality of page sequences, and holds the identifier of one page sequence to be the object for the present page turning process as the present sequence 16a. The page sequences hold the display index that indicates the page presently selected.

The viewpoint sequence managing unit 14 includes the viewpoint sequence definition table 14a, and searches the task management table 13a based on the search condition described in the viewpoint sequence definition table 14a. The viewpoint sequence managing unit 14 then generates a page sequence, stores the page sequence in the page attribution table 13b and the sequence management table 13c, and updates information in association with the update of the task management table 13a.

The page turning control unit 16 is a processing unit that includes a page turning unit 17, a sequence switching unit 18, and a subsequent page selecting unit 19, and performs various processes to pages using these units. The page turning unit 17 updates the display index held in the page sequence holding unit 13 according to a page turning request from the display unit 11, and outputs a request to the display unit 11 to display the page indicated by the display index in the page sequence.

The sequence switching unit 18 swishes the present sequence 16a to another page sequence. For example, the sequence switching unit 18 acquires a present sequence 16a and a present page indicated by the display index of the present sequence 16a, and extracts a page sequence including the present page from the page sequence holding unit 13. Subsequently, the sequence switching unit 18 selects one page sequence different from the present sequence 16a from the extracted page sequence group as a switch destination sequence, and determines the index of the present page in the switch destination sequence as a select index. In a case where the present sequence 16a is a display history, the sequence switching unit 18 then determines that the guidepost state 16b is fixed when the page indicated by the display index is the tail page of the present sequence 16a, whereas the sequence switching unit 18 determines that the guidepost state 16b is temporary when the page indicated by the display index is not the tail page.

Moreover, in a case where the present sequence 16a is a general sequence and the display index of the present sequence 16a is different from the guidepost index, the sequence switching unit 18 performs the following process. Namely, the sequence switching unit 18 adds the page indicated by the guidepost index of the present sequence 16a to the tail of the sequence stored in the display history DB 15 when the guidepost state 16b is temporary.

Moreover, the sequence switching unit 18 adds the page indicated by the display index of the present sequence 16a, changes the guidepost state 16b to be fixed. The sequence switching unit 18 adds the page indicated by the display index of the present sequence 16a to the tail of the display history sequence when the guidepost state 16b is fixed.

Furthermore, when the switch destination sequence is a general sequence, the sequence switching unit 18 substitutes the select index for the display index and the guidepost index of the switch destination sequence, and stores an identifier that identifies the switch destination sequence as the present sequence 16a. Subsequently, the sequence switching unit 18 generates display data of the page indicated by the display index of the switch destination sequence, and updates the display unit 11 with the display data.

The subsequent page selecting unit 19 switches the present page to another page. For example, the subsequent page selecting unit 19 operates the page transition managing unit 12 to acquire a subsequent page identifier, a subsequent sequence identifier, and an update index. In a case where the subsequent page identifier is not undetermined, the subsequent page selecting unit 19 then adds the page indicated by the subsequent page identifier to the tail of the sequence stored in the display history DB 15 when the present sequence 16a is a display history and the page indicated by the display index is the tail page of the present sequence 16a.

Moreover, in a case where the present sequence 16a is a display history and the page indicated by the display index is not the tail page of the present sequence 16a, the subsequent page selecting unit 19 adds the page indicated by the display index to the tail of the sequence stored in the display history DB 15. Furthermore, the subsequent page selecting unit 19 adds the page indicated by the subsequent page identifier.

In addition, when the present sequence 16a is a general sequence and the guidepost state 16b is temporary, the subsequent page selecting unit 19 adds the page indicated by the guidepost index to the tail of the display history sequence, and changes the guidepost state 16b to fixed. On the other hand, in a case where the present sequence 16a is a general sequence and the display index is different from the guidepost index, the subsequent page selecting unit 19 adds the page indicated by the display index to the tail of the sequence stored in the display history DB 15, and further adds the page indicated by the subsequent page identifier.

Moreover, in a case where the present sequence 16a is a general sequence and the display index is the same as the guidepost index, the subsequent page selecting unit 19 adds the page indicated by the subsequent page identifier to the tail of the display history sequence. On the other hand, when the present sequence 16a is a general sequence and the subsequent sequence of the general sequence is different from the subsequent sequence of the present sequence 16a, the subsequent page selecting unit 19 stores an identifier that identifies the subsequent sequence as the present sequence 16a. Furthermore, when the present sequence 16a is a general sequence, the subsequent page selecting unit 19 substitutes a value that the update index is incremented by one for the display index and the guidepost index of the present sequence 16a. In addition, the subsequent page selecting unit 19 generates display data of the page indicated by the display index of the present sequence 16a, and updates the display unit 11 with the display data.

The subsequent page selecting unit 19 operates the page transition managing unit 12 to acquire a subsequent page identifier, a subsequent sequence identifier, and an update index, and performs the following process in a case where the subsequent page identifier is undetermined. For example, in a case where the present sequence 16a is a display history and the page indicated by the display index is not the tail page of the present sequence 16a, the subsequent page selecting unit 19 adds the page indicated by the display index to the tail of the display history sequence.

Moreover, when the present sequence 16a is a general sequence and the guidepost state 16b is temporary, the subsequent page selecting unit 19 adds the page indicated by the guidepost index to the tail of the display history sequence, and changes the guidepost state 16b to fixed. In a case where the present sequence 16a is a general sequence and the display index is different from the guidepost index, the subsequent page selecting unit 19 then adds the page indicated by the display index to the tail of the display history sequence. Furthermore, when the present sequence 16a is a general sequence, the subsequent page selecting unit 19 substitutes the display index for the guidepost index of the present sequence 16a, generates display data of the page indicated by the display index of the present sequence 16a, and updates the display unit 11 with the display data.

Criteria when Switching a Sequence

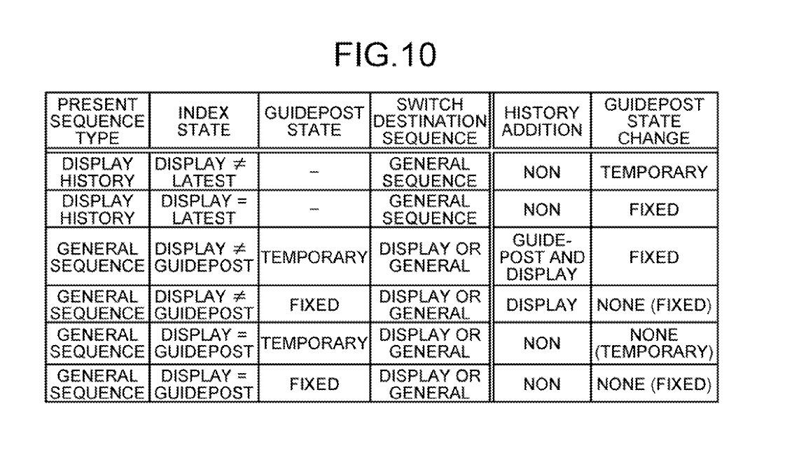

Next, exemplary determination will be described in which the page turning control unit 16 manages the guidepost state 16b and determines a page as an object to be added to the display history DB 15. FIG. 10 is a diagram of exemplary criteria for adding a page in a display history when switching a sequence. As illustrated in FIG. 10, the criteria are formed of “a present sequence type, an index state, a guidepost state, a switch destination sequence, history addition, and a guidepost state change”. Four items, “the present sequence type, the index state, the guidepost state, and the switch destination sequence”, are conditions for input, and two items, “history addition and the guidepost state change”, represent state changes for output.

“The present sequence type” is a condition that indicates the sequence type of the sequence identified by the present sequence 16a. As discussed above, the sequence type represents a distinction between the task sequence, the viewpoint sequence, and the display history sequence, and any one of the task, the viewpoint, and the display is set to the sequence type. The viewpoint sequence and the task sequence are combined and integrally referred to as a general sequence. “The index state” is a conditional expression that indicates the relationship between the display index, the guidepost index, and the latest index of the sequence identified by the present sequence 16a. “The guidepost state” is a condition that indicates whether the guidepost state 16b is temporary or fixed. “The switch destination sequence” is a condition that indicates the sequence type of the sequence that is a switched destination in a case where the sequence is switched. “History addition” is information that indicates a page added to the display history DB 15. In a case of “the guidepost and display”, it indicates adding the page indicated by the guidepost index of the present sequence and the page indicated by the display index to the display history. Moreover, in a case of “display”, it indicates adding only the page indicated by the display index of the present sequence to the display history. “The guidepost state change” is information that indicates whether the guidepost state 16b is changed to temporary or fixed. In other words, a page to be added to a history and a change in the guidepost state 16b are varied according to the type of the present sequence, the index state, the guidepost state, and the type of the switch destination sequence.

Exemplary determination will be described based on FIG. 10. In a case where a sequence is switched to a general sequence in the state in which the present sequence 16a is a display history and the display index is not the latest index, the first row in FIG. 10 corresponds to this case, indicating that no addition is made to the display history and the guidepost state 16b is changed to be temporary. Moreover, suppose that a sequence is switched to a general sequence or a display history in the state in which the present sequence 16a is a general sequence, the display index is not matched with the guidepost index, and the guidepost state 16b is temporary. The third row in FIG. 10 corresponds to this case, indicating that the page indicated by the guidepost index and the page indicated by the display index are added to the display history DB 15, and the guidepost state 16b is changed to fixed.

Process Flow when Switching a Sequence

Next, a process flow performed by the information processing apparatus 10 according to the first embodiment when switching a sequence will be described. Here, the page turning process, the sequence switching process, a sequence switching history process, and a display history adding subprocess will be described. It is noted that the processing units can be arbitrarily divided or integrated, and it may be possible to arbitrarily allocate which process to which processing unit.

Page Turning Process

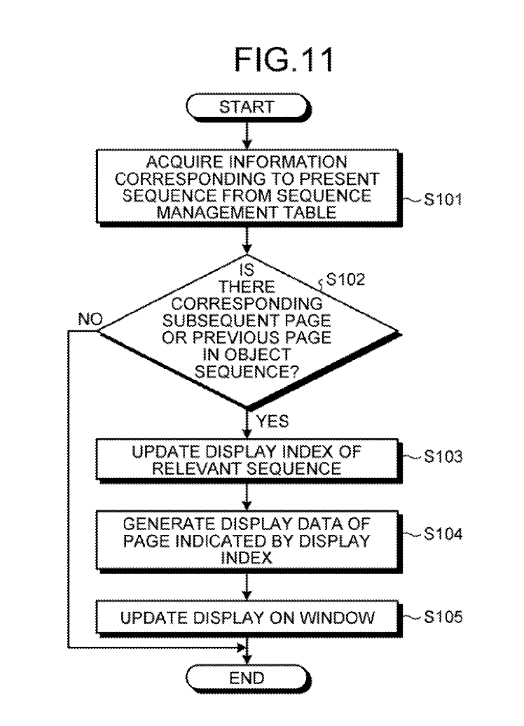

FIG. 11 is a flowchart of a flow of the page turning process. As illustrated in FIG. 11, the information processing apparatus 10 acquires information corresponding to the present sequence 16a from the sequence management table 13c (S101), and determines whether there is the corresponding subsequent page or previous page in an object sequence (S102).

Subsequently, in a case where the information processing apparatus 10 determines that there is the corresponding subsequent page or previous page in the object sequence (Yes in S102), the information processing apparatus 10 updates the display index of the sequence (S103). The information processing apparatus 10 then generates display data of the page indicated by the display index (S104), and updates the display unit 11, that is, updates the display on the window (S105).

It is noted that in a case where the information processing apparatus 10 determines that there is not the corresponding subsequent page or previous page in the object sequence (No in S102), the information processing apparatus 10 ends the page turning process.

Sequence Switching Process

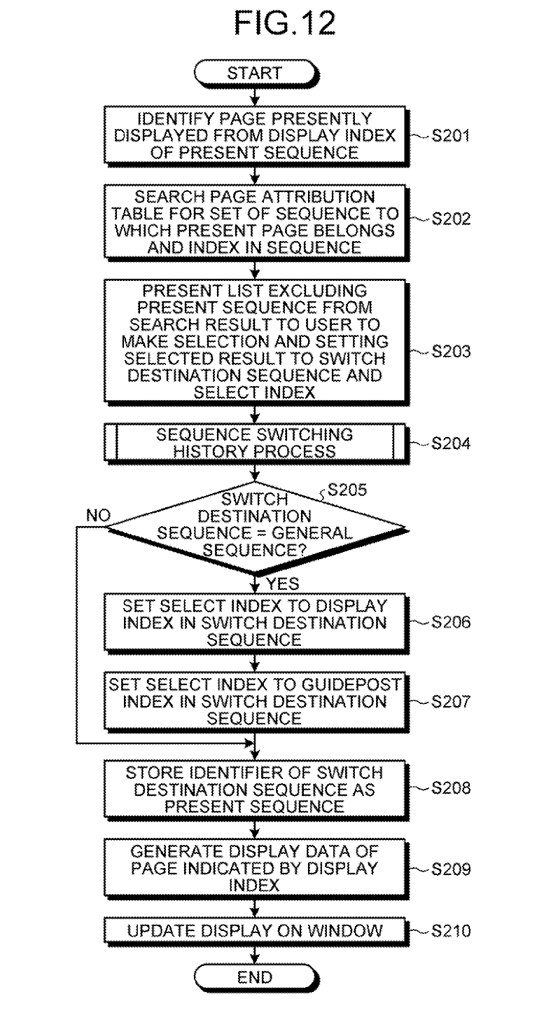

FIG. 12 is a flowchart of a flow of the sequence switching process. As illustrated in FIG. 12, the information processing apparatus 10 identifies a page presently displayed from the display index of the present sequence 16a (S201). Subsequently, the information processing apparatus 10 searches the page attribution table 13b for a set of a sequence to which the present page belongs and an index in the sequence (S202). The search result is a list including a set of the sequence identifier and the page index as elements.

The information processing apparatus 10 then presents the list excluding the present sequence 16a from the search result to the user and allows the user to make a select through the display unit 11 or the like, and determines the sequence identifier and the page index, which are the selected results, as a switch destination sequence and a select index (S203). After that, the information processing apparatus 10 performs the sequence switching history process described later (S204).

After performing the sequence switching history process, in a case where the switch destination sequence is a general sequence (Yes in S205), the information processing apparatus 10 stores the value of the select index in the display index of the switch destination sequence (S206). The information processing apparatus 10 then stores the value of the select index in the guidepost index of the switch destination sequence (S207).

After that, the information processing apparatus 10 stores the identifier of the switch destination sequence as the present sequence 16a (S208), generates display data of the page indicated by the display index of the present sequence (S209), and updates the display on the window (S210). It is noted that in a case where the switch destination sequence is not a general sequence (No in S205), the information processing apparatus 10 performs S208 without performing S206 and S207.

Sequence Switching History Process

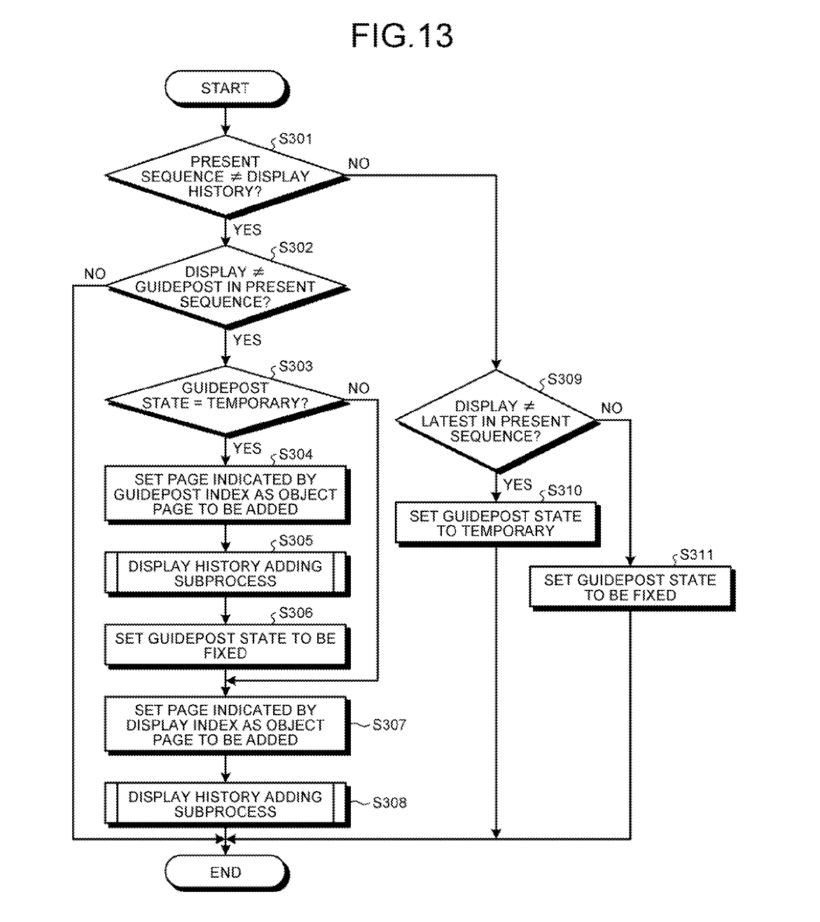

The sequence switching history process performs processes corresponding to history addition and a change in the guidepost state based on the criteria of the display history in FIG. 10. FIG. 13 is a flowchart of a flow of the sequence switching history process. This process is a process performed in S204 in FIG. 12.

As illustrated in FIG. 13, in a case where the present sequence 16a is not a display history (Yes in S301), the information processing apparatus 10 determines whether the display index of the present sequence 16a is different from the guidepost index (S302). In a case where the information processing apparatus 10 determines that the display index of the present sequence 16a is different from the guidepost index (Yes in S302), the information processing apparatus 10 then determines whether the guidepost state 16b is temporary (S303).

In a case where the information processing apparatus 10 determines that the guidepost state 16b is temporary (Yes in S303), the information processing apparatus 10 determines the page indicated by the guidepost index as the object page to be added (S304), and performs the display history adding subprocess (S305). After performing the display history adding subprocess, the information processing apparatus 10 changes the guidepost state 16b to fixed (S306).

Subsequently, the information processing apparatus 10 determines the page indicated by the display index as the object page to be added (S307), performs the display history adding subprocess (S308), and ends the process. It is noted that in a case where the information processing apparatus 10 determines that the guidepost state 16b is not temporary in S303 (No in S303), the information processing apparatus 10 performs S307 and S308 without performing S304, S305, and S306. Moreover, in a case where the information processing apparatus 10 determines that the display index of the present sequence 16a is matched with the guidepost index in S302 (No in S302), the information processing apparatus 10 ends the process without performing S303 to S308.

Furthermore, in a case where the information processing apparatus 10 determines that the present sequence 16a is a display history in S301 (No in S301), the information processing apparatus 10 determines whether the display index of the present sequence 16a is different from the latest index (S309). In a case where the information processing apparatus 10 determines that the display index of the present sequence 16a is different from the latest index (Yes in S309), the information processing apparatus 10 then sets the guidepost state 16b to temporary (S310). On the other hand, in a case where the information processing apparatus 10 determines that the display index of the present sequence 16a is matched with the latest index (No in S309), the information processing apparatus 10 sets the guidepost state 16b to be fixed (S311).

Display History Adding Subprocess

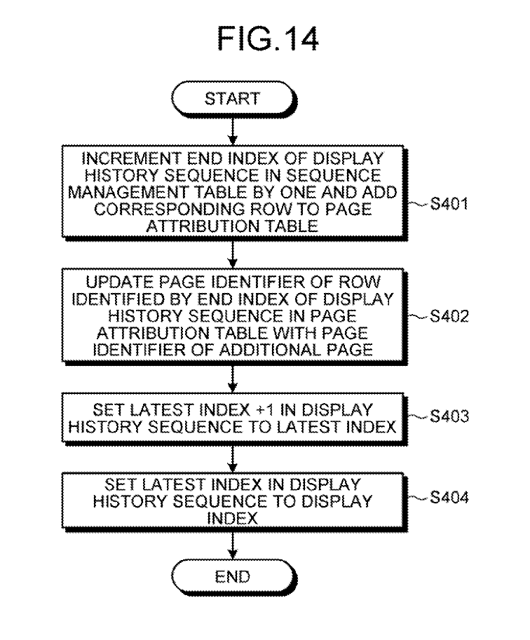

FIG. 14 is a flowchart of a flow of the display history adding subprocess. This process is a process performed in S305 and S308 in FIG. 13.

As illustrated in FIG. 14, the information processing apparatus 10 increments the end index of the display history sequence in the sequence management table 13c, and adds a row corresponding to the end index of the display history sequence to the page attribution table 13b (S401). Subsequently, the information processing apparatus 10 updates the page identifier of the row identified by the end index of the display history sequence in the page attribution table 13b with the page identifier of the additional page (S402).

After that, the information processing apparatus 10 increments the latest index of the display history sequence (S403), sets the value of the latest index to the display index of the display history sequence (S404), and ends the process.

Specific Examples when Switching a Sequence

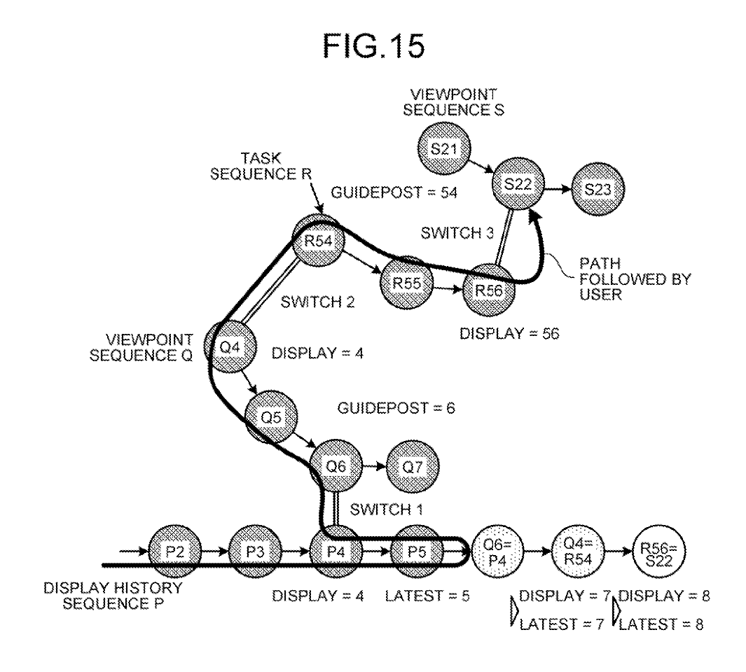

Next, specific examples will be described with reference to FIGS. 15 to 18 in which the information processing apparatus 10 switches a sequence and updates the display history. It is noted that circles in the drawings indicate pages, and characters in the circles indicate sequences and page numbers. For example, in a case of P2, P2 indicates a page 2 of a sequence P. In a case of R54, R54 indicates a page 54 of a sequence R. The notation including an equal sign like Q6=P4 in a circle indicates that a page 6 of a sequence Q and a page 4 of the sequence P are the same page having the same page identifier. Moreover, smaller numerical characters indicate older pages in sequences, that is, smaller numerical characters indicate previous pages.

First Specific Example

FIG. 15 is a diagram of a first specific example when switching a sequence. As illustrated in FIG. 15, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and performs a sequence switch 1 to a viewpoint sequence Q in the state in which the page 4 of the sequence P is displayed.

Namely, the information processing apparatus 10 switches to the viewpoint sequence Q in a state in which the latest index is P5 and the display index is P4. In this example, the page 4 of the sequence P corresponded to a page 6 of the sequence Q. The information processing apparatus 10 then identifies that the present sequence 16a is a display history, the index state is as the display index (P4)≠the latest index (P5), the guidepost state 16b is not set, and the switch destination sequence is a general sequence. In other words, since the case corresponds to the first row in FIG. 10, the information processing apparatus 10 sets the guidepost state 16b to temporary, and makes no addition to the history. The information processing apparatus 10 then sets the page 6 of the viewpoint sequence Q of the switch destination to the guidepost index of the sequence Q.

After that, the information processing apparatus 10 accepts a user manipulation, and turns the page 6, a page 5, and a page 4 of the viewpoint sequence Q. The information processing apparatus 10 then accepts a user manipulation, and performs a sequence switch 2 to a task sequence R in the state in which the page 4 of the viewpoint sequence Q is displayed.

Namely, the information processing apparatus 10 switches to the task sequence R in the state in which the display index is Q4 and the guidepost index is Q6. In this example, the page 6 of the sequence Q corresponded to a page 54 of the sequence R. The information processing apparatus 10 then identifies that the present sequence 16a is a general sequence, the index state is as the display index (Q4)≠the guidepost index (Q6), the guidepost state 16b is temporary, and the switch destination sequence is a general sequence. In other words, since the case corresponds to the third row in FIG. 10, the information processing apparatus 10 sets the guidepost state 16b to fixed, and adds the page indicated by the guidepost index (Q6) and the page indicated by the display index (Q4) as the history of the display history sequence P. Since two pages (Q6 and Q4) are added, the latest index and the display index of the display history sequence P are turned to be seven. The information processing apparatus 10 then sets the page 54 of the task sequence R of the switch destination to the guidepost index of the sequence R.

After that, the information processing apparatus 10 accepts a user manipulation, and turns the page 54, a page 55, and a page 56 of the task sequence R. The information processing apparatus 10 then accepts a user manipulation, and performs a sequence switch 3 to a viewpoint sequence S in the state in which the page 56 of the task sequence R is displayed.

Namely, the information processing apparatus 10 switches to the viewpoint sequence S in the state in which the display index is R56 and the guidepost index is R54. In this example, the page 54 of the sequence R corresponded to a page 22 of the sequence S. The information processing apparatus 10 then identifies that the present sequence 16a is a general sequence, the index state is as the display index (R56)≠the guidepost index (R54), the guidepost state 16b is fixed, and the switch destination sequence is a general sequence. In other words, since the case corresponds to the fourth row in FIG. 10, the information processing apparatus 10 sets the guidepost state 16b to fixed, and adds the page indicated by the display index (R56) as the history of the display history sequence P. Since one page (R56) is added, the latest index and the display index of the display history sequence P are turned to be eight.

In the case of FIG. 15, the user browses the page 2, the page 3, the page 4, the page 5, and the page 4 of the display history sequence P, and then browses the page 6, the page 5, and the page 4 of the sequence Q. After that, the user browses the page 54, the page 55, and the page 56 of the sequence R, switches the sequence displayed on the page 56 of the sequence R to browse the page 22 of the sequence S, and reaches a desired page. In this case, since the information processing apparatus 10 holds the branch points as a history, the information processing apparatus 10 holds the page 6 of the sequence Q (the same as the page 4 of the sequence P), the page 4 of the sequence Q (the same as the page 54 of the sequence R), and the page 56 of the sequence R (the same as the page 22 of the sequence S) as the history of the sequence P subsequent to the page 2, the page 3, the page 4, and the page 5 of the display history sequence P.

Second Specific Example

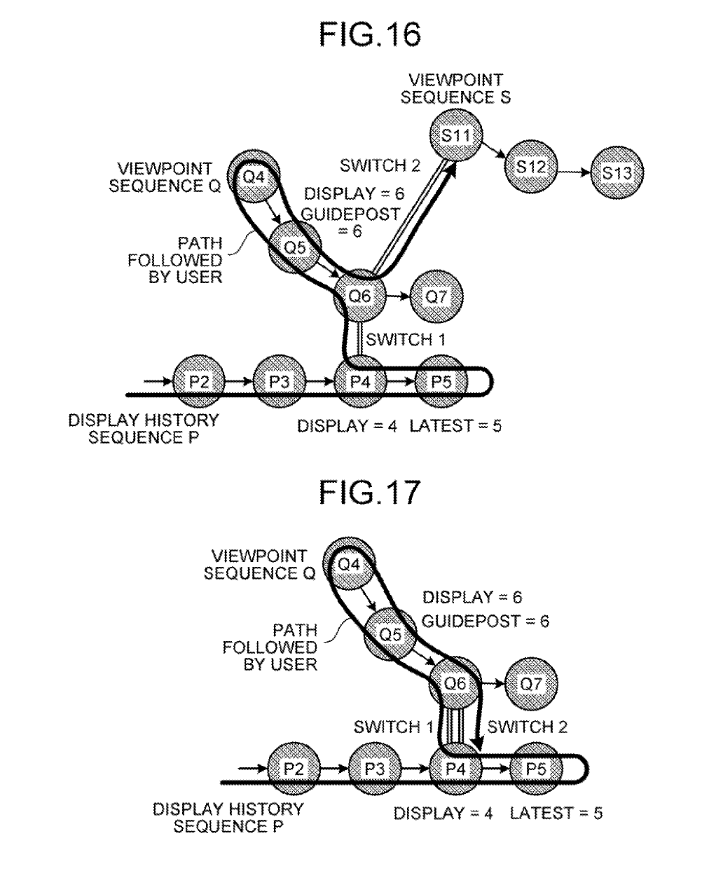

FIG. 16 is a diagram of a second specific example when switching a sequence. As illustrated in FIG. 16, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and performs a sequence switch 1 to a viewpoint sequence Q in the state in which the page 4 of the sequence P is displayed.

Namely, the information processing apparatus 10 switches to the viewpoint sequence Q in the state in which the latest index is P5 and the display index is P4. In this example, the page 4 of the sequence P corresponds to a page 6 of the sequence Q. The information processing apparatus 10 then identifies that the present sequence 16a is a display history, the index state is as the display index≠the latest index, the guidepost state 16b is not set, and the switch destination sequence is a general sequence. In other words, since the case corresponds to the first row in FIG. 10, the information processing apparatus 10 sets the guidepost state 16b to temporary, and makes no addition to the history. The information processing apparatus 10 then sets the page 6 of the viewpoint sequence Q of the switch destination to the guidepost index of the sequence Q.

After that, the information processing apparatus 10 accepts a user manipulation, and turns the page 6, a page 5, and a page 4 of the viewpoint sequence Q. Moreover, the information processing apparatus 10 accepts a user manipulation, and the pages are switched in order of the page 4, the page 5, and the page 6, and performs a sequence switch 2 to a viewpoint sequence S in the state in which the page is returned to the page 6.

Namely, the information processing apparatus 10 switches to the viewpoint sequence S in the state in which the display index is Q6 and the guidepost index is Q6. In this example, the page 6 of the sequence Q corresponds to a page 11 of the sequence S. The information processing apparatus 10 then identifies that the present sequence 16a is a general sequence, the index state is as the display index (Q6)=the guidepost index (Q6), the guidepost state 16b is temporary, and the switch destination sequence is a general sequence. In other words, since the case corresponds to the fifth row in FIG. 10, the information processing apparatus 10 sets the guidepost state 16b to temporary as it is, and does not add anything to the history of the display history sequence P. The information processing apparatus 10 then sets the page 11 of the viewpoint sequence S of the switch destination to the guidepost index of the sequence S.

As described above, in the example in FIG. 16, since the guidepost index is equal to the display index at the switch 2, the information processing apparatus 10 does not add anything to the history, and does not add the switch to the redundant sequence Q, to which only information is referenced, to the history.

Third Specific Example

FIG. 17 is a diagram of a third specific example when switching a sequence. As illustrated in FIG. 17, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and performs a sequence switch 1 to a viewpoint sequence Q in the state in which the page 4 of the sequence P is displayed.

Namely, the information processing apparatus 10 switches to the viewpoint sequence Q in the state in which the latest index is P5 and the display index is P4. In this example, the page 4 of the sequence P corresponds to a page 6 of the sequence Q. The information processing apparatus 10 then identifies that the present sequence 16a is a display history, the index state is as the display index≠the latest index, the guidepost state 16b is not set, and the switch destination sequence is a general sequence. In other words, since the case corresponds to the first row in FIG. 10, the information processing apparatus 10 sets the guidepost state 16b to temporary, and makes no addition to the history. The information processing apparatus 10 then sets the page 6 of the viewpoint sequence Q of the switch destination to the guidepost index of the sequence Q.

After that, the information processing apparatus 10 accepts a user manipulation, and turns the page 6, a page 5, and a page 4 of the viewpoint sequence Q. Moreover, the information processing apparatus 10 accepts a user manipulation, the pages are switched in order of the page 4, the page 5, and the page 6, and performs a sequence switch 2 to the display history sequence P, which is a switch source, in the state in which the page is returned to the page 6.

Namely, the information processing apparatus 10 switches to the viewpoint sequence P in the state in which the display index is Q6 and the guidepost index is Q6. The information processing apparatus 10 then identifies that the present sequence 16a is a general sequence, the index state is as the display index (Q6)=the guidepost index (Q6), the guidepost state 16b is temporary, and the switch destination sequence is a general sequence. In other words, since the case corresponds to the fifth row in FIG. 10, the information processing apparatus 10 sets the guidepost state 16b to temporary as it is, and does not add anything to the history of the display history sequence P.

As described above, in the example in FIG. 17, since the guidepost index is equal to the display index at the switch 2, the information processing apparatus 10 does not add anything to the history, determines that only information is referenced to the viewpoint sequence Q, and does not add the pages of the sequence Q displayed on the display unit 11 to the history.

Fourth Specific Example

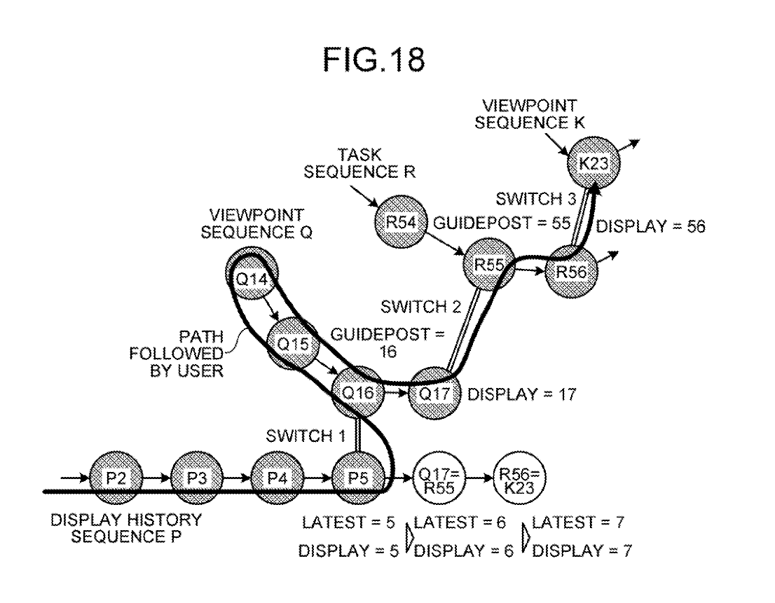

FIG. 18 is a diagram of a fourth specific example when switching a sequence. As illustrated in FIG. 18, the information processing apparatus 10 in turn displays a page 2, a page 3, a page 4, and a page 5 of a display history sequence P, which is a sequence first displayed, and performs a sequence switch 1 to a viewpoint sequence Q in the state in which the page 5 of the sequence P is displayed.

Namely, the information processing apparatus 10 switches to the viewpoint sequence Q in the state in which the latest index is P5 and the display index is P5. In this example, the page 5 of the sequence P corresponds to a page 16 of the sequence Q. The information processing apparatus 10 then identifies that the present sequence 16a is a display history, the index state is as the display index=the latest index, the guidepost state 16b is not set, and the switch destination sequence is a general sequence. In other words, since the case corresponds to the second row in FIG. 10, the information processing apparatus 10 sets the guidepost state 16b to fixed, and does not add anything to the history. The information processing apparatus 10 then sets the page 16 of the viewpoint sequence Q of the switch destination to the guidepost index of the sequence Q.

After that, the information processing apparatus 10 accepts a user manipulation, and turns the page 16, a page 15, and a page 14 of the viewpoint sequence Q. Moreover, the information processing apparatus 10 accepts a user manipulation, switches to the page 14, the page 15, the page 16, and a page 17, and performs a sequence switch 2 to a task sequence R in the state of the page 17.

Namely, the information processing apparatus 10 switches to the task sequence R in the state in which the display index is Q17 and the guidepost index is Q16. In this example, the page 17 of the sequence Q corresponds to a page 55 of the sequence R. The information processing apparatus 10 then identifies that the present sequence 16a is a general sequence, the index state is as the display index (Q17)≠the guidepost index (Q16), the guidepost state 16b is fixed, and the switch destination sequence is a general sequence. In other words, since the case corresponds to the fourth row in FIG. 10, the information processing apparatus 10 sets the guidepost state 16b to fixed as it is, and adds the page indicated by the display index (Q17) as the history of the display history sequence P. The information processing apparatus 10 then sets the page 55 of the task sequence R of the switch destination to the guidepost index of the sequence R. Since one page (Q17) is added, the latest index and the display index of the display history sequence P are turned to be six.

After that, the information processing apparatus 10 accepts a user manipulation, and performs a sequence switch 3 to a viewpoint sequence K in the state in which the page 55 of the task sequence R is switched to a page 56.

Namely, the information processing apparatus 10 switches to the viewpoint sequence K in the state in which the display index is R56 and the guidepost index is R55. In this example, the page 56 of the sequence R corresponds to a page 23 of the sequence K. The information processing apparatus 10 then identifies that the present sequence 16a is a general sequence, the index state is as the display index (R56)≠the guidepost index (R55), the guidepost state 16b is fixed, and the switch destination sequence is a general sequence. In other words, since the case corresponds to the fourth row in FIG. 10, the information processing apparatus 10 sets the guidepost state 16b to fixed, and adds the page indicated by the display index (R56) as the history of the display history sequence P. Since one page (Q17) is added, the latest index and the display index of the display history sequence P are turned to be seven.

In the case of FIG. 18, the user browses the page 2, the page 3, the page 4, and the page 5 of the display history sequence P, and then browses the page 16, the page 15, and the page 14 of the sequence Q. After that, the user displays the page 14, the page 15, the page 16, and the page 17 of the sequence Q, browses the page 55 and the page 56 of the sequence R, switches to the sequence K, and browses the page 23 of the sequence K. In this case, although the information processing apparatus 10 holds the branch points as a history, the information processing apparatus 10 determines that the page 16, the page 15, and the page 14 are not counted as a history because only a reference is made to the page 14, the page 15, and the page 16 of the sequence Q and the page is transitioned from the page 16 to the page 17. As a result, the information processing apparatus 10 holds the page 17 of the sequence Q (the page 55 of the sequence R) and the page 56 of the sequence R (the page 23 of the sequence K) as the history of the sequence P subsequent to the page 2, the page 3, the page 4, and the page 5 of the display history sequence P.

Effect

In these sequence switches, in order to browse a desired page, the user switches between pages and turns pages to search for a desired page while browsing pages not directly related to a desired page. Therefore, the information processing apparatus 10 can store branch points at which page sequences are switched as a history, not all the pages used for searches by the user. As a result, it is possible to appropriately manage display histories including branches. Moreover, it is possible to perform efficient history searches, and it is possible to browse pages by turning pages regardless of the type of the sequence of interest.

Criteria when Selecting a Subsequent Page

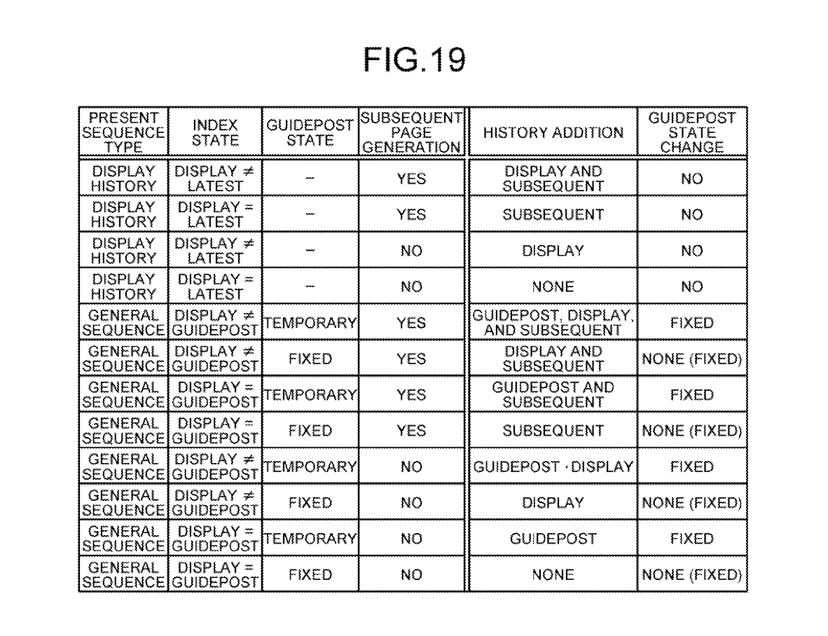

Next, exemplary determination will be described in which the page turning control unit 16 manages the guidepost state 16b and determines the page as an object to be added to the display history DB 15. FIG. 19 is a diagram of exemplary criteria for adding a page in a display history when selecting a subsequent page. As illustrated in FIG. 19, the criteria are formed of “a present sequence type, an index state, a guidepost state, subsequent page generation, history addition, and a guidepost state change”.

As apparent from the comparison of FIG. 19 with FIG. 10, the point different from the criteria when switching a sequence illustrated in FIG. 10 is in that the column of “subsequent page generation” is added, which indicates whether a subsequent page is generated, instead of the column of “the switch destination sequence”. In other words, in a case where the subsequent page select process occurs, the information processing apparatus 10 determines addition to the history using FIG. 19, whereas in a case where the subsequent page select process does not occur and only the sequence switching process occurs, the information processing apparatus 10 determines addition to the history using FIG. 10.

Here, a first row, a seventh row, and a tenth row in FIG. 19 will be described as examples. The first row is information that indicates addition to a history in a case where a subsequent page is generated in the state in which the sequence type of the present sequence 16a is a display history and the displayed page is not the latest page. In this case, the first row indicates that the page indicated by the display index and the generated subsequent page are added to the display history DB 15 and the guidepost state 16b is not changed.

Moreover, the seventh row is information that indicates addition to a history in a case where a subsequent page is generated in the state in which the present sequence 16a is a general sequence, the display index is matched with the guidepost index, and the guidepost state 16b is temporary. In this case, the seventh row indicates that the page indicated by the guidepost index and the generated subsequent page are added to the display history DB 15 and the guidepost state 16b is changed to fixed.

Furthermore, the tenth row is information that indicates addition to a history in a case where no subsequent page is generated in the state in which the present sequence 16a is a general sequence, the display index is not matched with the guidepost index, and the guidepost state 16b to be fixed. In this case, the tenth row indicates that the page indicated by the display index is added to the display history DB 15 and the guidepost state 16b is not changed as the guidepost state 16b is fixed.

Process Flow when Selecting a Subsequent Page

Next, a process flow performed by an information processing apparatus 10 according to a second embodiment will be described. Here, the subsequent page select process, a subsequent page transition process, and a subsequent page select history process related to selecting a subsequent page will be described. It is noted that the processing units can be arbitrarily divided or integrated, and it may be possible to arbitrarily allocate which process to which processing unit.

Subsequent Page Select Process

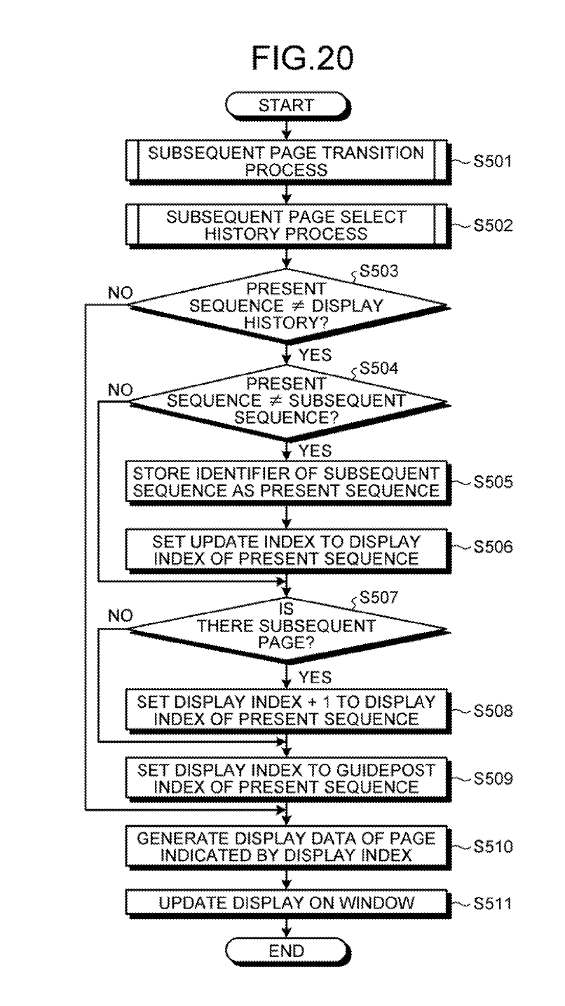

FIG. 20 is a flowchart of a flow of the subsequent page select process. As illustrated in FIG. 20, the information processing apparatus 10 performs the subsequent page transition process (S501), performs the subsequent page select history process (S502), and then determines whether the present sequence 16a is a display history (S503).

In a case where the information processing apparatus 10 determines that the present sequence 16a is a display history (Yes in S503), the information processing apparatus 10 then determines whether the present sequence 16a is a subsequent sequence (S504). Subsequently, in a case where the information processing apparatus 10 determines that the present sequence 16a is a subsequent sequence (Yes in S504), the information processing apparatus 10 stores the identifier of the subsequent sequence as the present sequence 16a (S505), and sets the value of the update index to the display index of the present sequence 16a (S506). It is noted that in a case where the information processing apparatus 10 determines that the present sequence 16a is not a subsequent sequence (No in S504), the information processing apparatus 10 performs S507 without performing S505 and S506.

After that, the information processing apparatus 10 determines whether there is a subsequent page (S507). In a case where the information processing apparatus 10 determines that there is a subsequent page (Yes in S507), the information processing apparatus 10 sets the value that the display index is incremented to the display index of the present sequence 16a (S508).

The information processing apparatus 10 then sets the value of the display index to the guidepost index of the present sequence 16a (S509), generates display data of the page indicated by the display index (S510), and updates the display unit 11, that is, updates the display on the window (S511).

It is noted that in a case where the information processing apparatus 10 determines that there is no subsequent page in S507 (No in S507), the information processing apparatus 10 performs S509 without performing S508. Moreover, in a case where the information processing apparatus 10 determines that the present sequence 16a is not a display history in S503 (No in S503), the information processing apparatus 10 performs S510 without performing S504 to S509.

Subsequent Page Transition Process

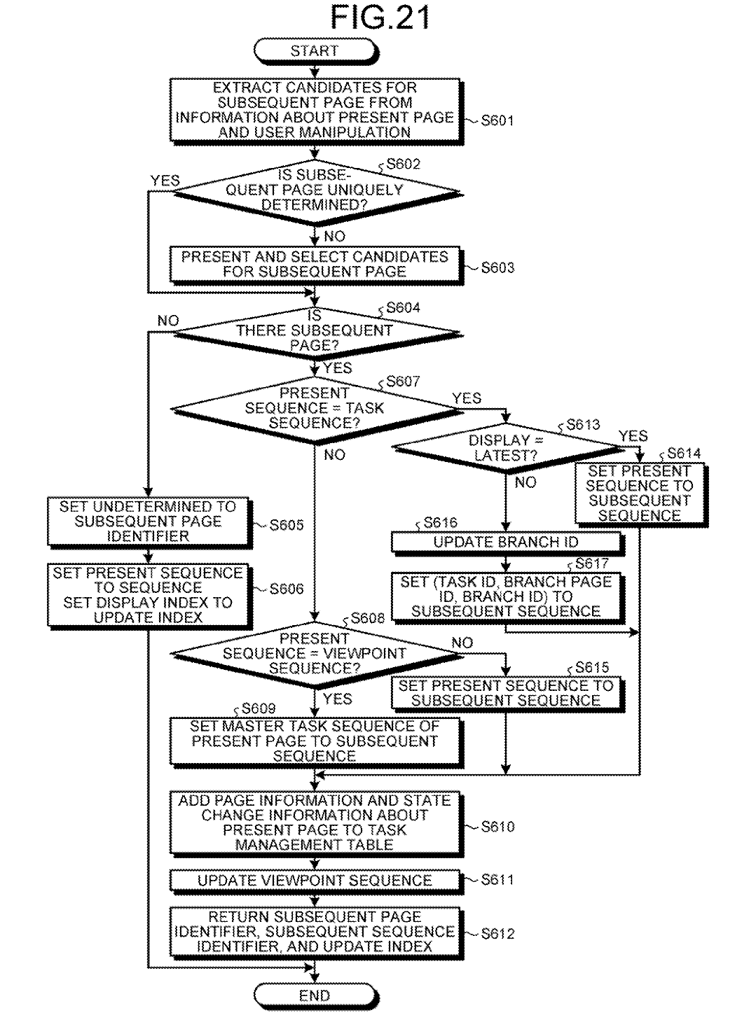

FIG. 21 is a flowchart of a flow of the subsequent page transition process. This process is a process performed in S501 in FIG. 20.

As illustrated in FIG. 21, the information processing apparatus 10 extracts candidates for a subsequent page from information about the present page and a user manipulation (S601), and determines whether the subsequent page is uniquely determined (S602).

In a case where the subsequent page is not uniquely determined (No in S602), the information processing apparatus 10 then displays select candidates for the subsequent page on the display unit 11, and allows the user to select one (S603). After that, in a case where there is no subsequent page (No in S604), the information processing apparatus 10 sets the subsequent page identifier to undetermined (S605), sets the value of the present sequence 16a to the subsequent sequence, sets the value of the display index to the update index (S606), and ends the process. It is noted that in a case where the subsequent page is uniquely determined (Yes in S602), the information processing apparatus 10 performs S604 without performing S603.

On the other hand, in a case where there is a subsequent page (Yes in S603), the information processing apparatus 10 determines whether the present sequence 16a is a task sequence (S607). In a case where the information processing apparatus 10 determines that the present sequence 16a is not a task sequence (No in S607), the information processing apparatus 10 then determines whether the present sequence 16a is a viewpoint sequence (S608).

Subsequently, in a case where the information processing apparatus 10 determines that the present sequence 16a is a viewpoint sequence (Yes in S608), the information processing apparatus 10 sets the master task sequence of the present page to the subsequent sequence (S609). The information processing apparatus 10 then adds subsequent page information and state change information about the present page to the task management table 13a (S610), and updates the viewpoint sequence managed by the sequence management table 13c or the like (S611). After that, the information processing apparatus 10 returns the subsequent page identifier, the subsequent sequence identifier, and the update index to the subsequent page select process (S612).

It is noted that in a case where the information processing apparatus 10 determines that the present sequence 16a is not a viewpoint sequence in S608 (No in S608), the information processing apparatus 10 sets the present sequence 16a to the subsequent sequence (S615), and then performs S610 and steps after S610.

Moreover, in a case where the information processing apparatus 10 determines that the present sequence 16a is a task sequence in S607 (Yes in S607), the information processing apparatus 10 determines whether the display index is matched with the latest index (S613).

In a case where the information processing apparatus 10 determines that the display index is matched with the latest index (Yes in S613), the information processing apparatus 10 then sets the present sequence 16a to the subsequent sequence (S614), and performs S610 and steps after S610.

On the other hand, in a case where the information processing apparatus 10 determines that the display index is not matched with the latest index (No in S613), the information processing apparatus 10 updates the branch ID (S616), sets {the task ID, the branched page ID, the branch ID} to the subsequent sequence (S617), and then performs S610 and steps after S610.

Subsequent Page Select History Process

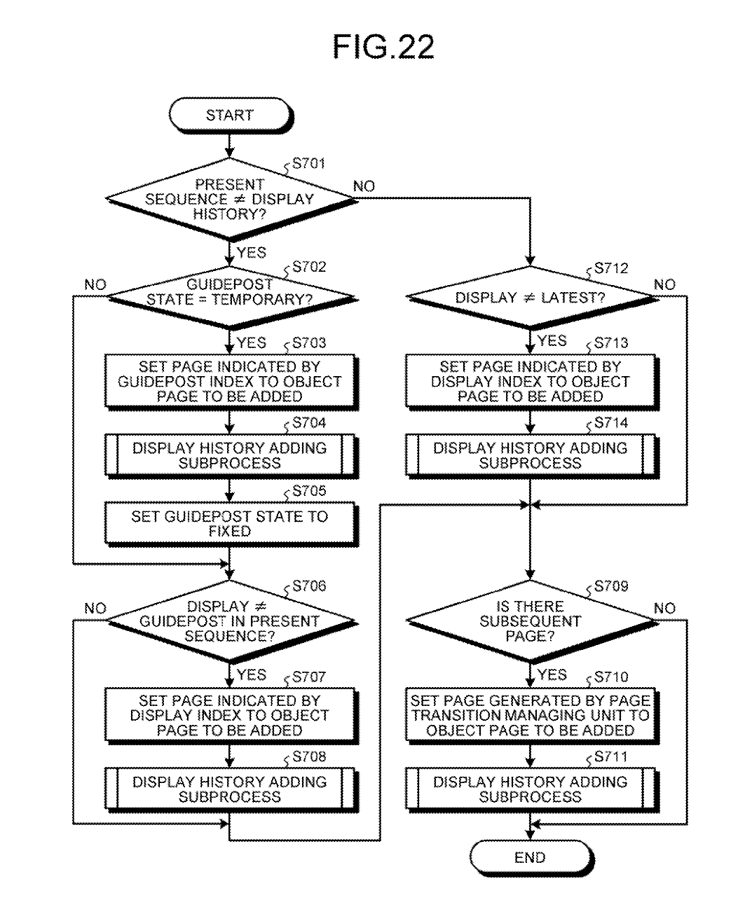

FIG. 22 is a flowchart of a flow of the subsequent page select history process. This process is a process performed in S502 in FIG. 20.

As illustrated in FIG. 22, in a case where the information processing apparatus 10 determines that the present sequence 16a is not a display history (Yes in S701), the information processing apparatus 10 determines whether the guidepost state 16b is temporary (S702). In a case where the information processing apparatus 10 determines that the guidepost state 16b is temporary (Yes in S702), the information processing apparatus 10 then sets the page indicated by the guidepost index to the object page to be added (S703).

After that, the information processing apparatus 10 performs the display history adding subprocess described in FIG. 14 (S704), and sets the guidepost state 16b to fixed (S705). In a case where the information processing apparatus 10 determines that the display index of the present sequence 16a is not matched with the guidepost index (Yes in S706), the information processing apparatus 10 then sets the page indicated by the display index to the object page to be added (S707). After that, the information processing apparatus 10 performs the display history adding subprocess described in FIG. 14 (S708).

Subsequently, in a case where there is a subsequent page (Yes in S709), the information processing apparatus 10 sets the subsequent page generated by the page transition managing unit 12 or the like to the object page to be added (S710), and performs the display history adding subprocess described in FIG. 14 (S711). On the other hand, in a case where there is no subsequent page (No in S709), the information processing apparatus 10 ends the process.

It is noted that in a case where the information processing apparatus 10 determines that the guidepost state 16b is not temporary in S702 (No in S702), the information processing apparatus 10 performs S706 without performing S703 to S705. Moreover, in a case where the information processing apparatus 10 determines that the display index of the present sequence 16a is matched with the guidepost index in S706 (No in S706), the information processing apparatus 10 performs S709 without performing S707 and S708.

On the other hand, in a case where the information processing apparatus 10 determines that the present sequence 16a is a display history in S701 (No in S701), the information processing apparatus 10 determines whether the display index is matched with the latest index (S712).

In a case where the information processing apparatus 10 determines that the display index is matched with the latest index (Yes in S712), the information processing apparatus 10 then sets the page indicated by the display index to the object page to be added (S713), and performs the display history adding subprocess described in FIG. 14 (S714). After that, the information processing apparatus 10 performs S709 and steps after S709. On the other hand, in a case where the information processing apparatus 10 determines that the display index is not matched with the latest index (No in S712), the information processing apparatus 10 performs S709 without performing S713 and S714.

Specific Examples when Selecting a Subsequent Page

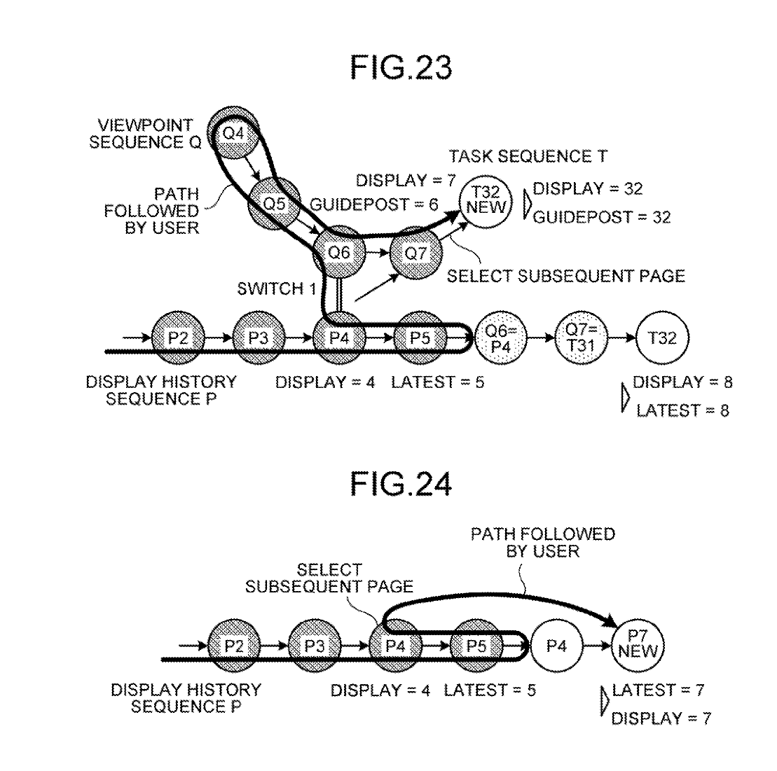

Next, specific examples will be described in which the information processing apparatus 10 selects the subsequent page and updates the display history with reference to FIGS. 23 to 28. It is noted that the notation in the drawings is the same as in the first embodiment.

First Specific Example

FIG. 23 is a diagram of a first specific example when selecting a subsequent page. As illustrated in FIG. 23, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and performs a sequence switch 1 to a viewpoint sequence Q in the state in which the page 4 of the sequence P is displayed.

The process for switching a sequence is the same as the case in the first embodiment. Namely, the information processing apparatus 10 switches to the viewpoint sequence Q in the state in which the latest index is P5 and the display index is P4. In this example, the page 4 of the sequence P corresponds to a page 6 of the sequence Q. The information processing apparatus 10 then identifies that the present sequence 16a is a display history, the index state is as the display index≠the latest index, the guidepost state 16b is not set, and the switch destination sequence is a general sequence. In other words, since the case corresponds to the first row in FIG. 10, the information processing apparatus 10 sets the guidepost state 16b to temporary, and makes no addition to the history.

After that, the information processing apparatus 10 accepts a user manipulation, and turns the page 6, a page 5, and a page 4 of the viewpoint sequence Q. Moreover, the information processing apparatus 10 accepts a user manipulation, switches to the page 4, the page 5, the page 6, and a page 7, and displays a page 32 of a task sequence T, which is the subsequent page, in the state of the page 7. For example, when the information processing apparatus 10 accepts a manipulation to select a subsequent page from the user on information displayed on the page 7 of the sequence Q, the information processing apparatus 10 selects the subsequent page according to the accepted manipulation, and displays the subsequent page on the display unit 11.

Namely, the information processing apparatus 10 selects the subsequent page 32 of the task sequence T in the state in which the display index is Q7 and the guidepost index is Q6. The information processing apparatus 10 then identifies that the present sequence 16a is a general sequence, the index state is as the display index (Q7)≠the guidepost index (Q6), the guidepost state 16b is temporary, and the subsequent page is generated. In other words, since the case corresponds to the fifth row in FIG. 19, the information processing apparatus 10 sets the guidepost state 16b to fixed, and adds the page indicated by the guidepost index (Q6), the page indicated by the display index (Q7), and the subsequent page (T32) as the history of the display history sequence P. The information processing apparatus 10 then sets the page 32 of the task sequence T of the switch destination to the guidepost index and the display index of the sequence T.

As a result, the information processing apparatus 10 stores Q6 (P4) after switching the sequence as the history subsequent to the page 5 of the display history sequence P originally displayed. Subsequently, the information processing apparatus 10 stores Q7 (T31) displayed when selecting the subsequent page, and then stores the new page T32. As described above, the information processing apparatus 10 can hold the page on which the sequence is switched, the page on which the subsequent page is selected, and a new page selected and displayed as branch points for a display history.

Second Specific Example

FIG. 24 is a diagram of a second specific example when selecting a subsequent page. As illustrated in FIG. 24, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and selects a subsequent page in the state in which the page 4 of the sequence P is displayed.

Namely, the information processing apparatus 10 selects a subsequent page 7 of the display history sequence P, which is the same sequence, in the state in which the latest index is P5 and the display index is P4. The information processing apparatus 10 then identifies that the present sequence 16a is a display history, the index state is as the display index (P4)≠the latest index (P5), and the subsequent page is generated. In other words, since the case corresponds to the first row in FIG. 19, the information processing apparatus 10 does not set anything to the guidepost state 16b, and adds the page indicated by the display index (P4) and the subsequent page (P7) as the history of the display history sequence P.

As a result, the information processing apparatus 10 stores P4 displayed when selecting the subsequent page as the history subsequent to the page 5 of the display history sequence P originally displayed, and then stores the new page P7. As described above, in a case where the subsequent page is selected in the same sequence, the information processing apparatus 10 can store the page on which the subsequent page is selected and a new page selected and displayed as the subsequent page in the history as branch points. For example, the information processing apparatus 10 can correctly hold branch points as a display history even in a case where such a process occurs in which pages are skipped from the page 4 to the page 7 for display, for example.

Third Specific Example

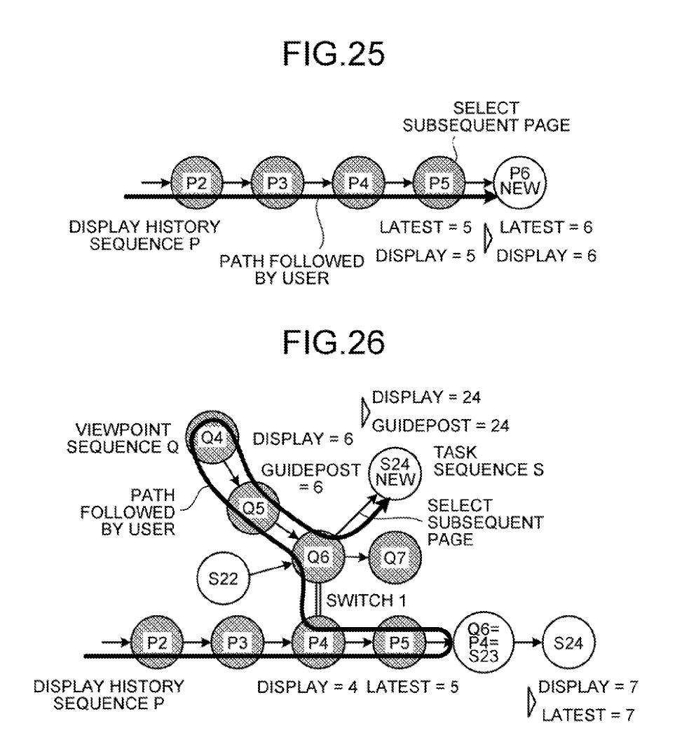

FIG. 25 is a diagram of a third specific example when selecting a subsequent page. As illustrated in FIG. 25, the information processing apparatus 10 in turn displays a page 2, a page 3, a page 4, and a page 5 of a display history sequence P, which is a sequence first displayed, accepts a user manipulation, and selects a subsequent page in the state of the page 5.

Namely, the information processing apparatus 10 selects a subsequent page 6 of the display history sequence P, which is the same sequence, in the state in which the latest index is P5 and the display index is P5. The information processing apparatus 10 then identifies that the present sequence 16a is a display history, the index state is as the display index (P5)=the latest index (P5), and the subsequent page is generated. In other words, since the case corresponds to the second row in FIG. 19, the information processing apparatus 10 does not set anything to the guidepost state 16b, and adds the subsequent page (P6) as the history of the display history sequence P.

As a result, the information processing apparatus 10 stores the new page P6 as the history subsequent to the page 5 of the display history sequence P originally displayed. As described above, in a case where the subsequent page is selected in the same sequence, the information processing apparatus 10 can store a new page selected and displayed in the display history as a branch point.

Fourth Specific Example

FIG. 26 is a diagram of a fourth specific example when selecting a subsequent page. As illustrated in FIG. 26, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and performs a sequence switch 1 to a viewpoint sequence Q in the state in which the page 4 of the sequence P is displayed.

The process for switching a sequence is the same as the case in the first embodiment. Namely, the information processing apparatus 10 switches to the viewpoint sequence Q in the state in which the latest index is P5 and the display index is P4. In this example, the page 4 of the sequence P corresponds to a page 6 of the sequence Q. The information processing apparatus 10 then identifies that the present sequence 16a is a display history, the index state is as the display index (P4)≠the latest index (P5), the guidepost state 16b is not set, and the switch destination sequence is a general sequence. In other words, since the case corresponds to the first row in FIG. 10, the information processing apparatus 10 sets the guidepost state 16b to temporary, and makes no addition to the history. The information processing apparatus 10 then sets the page 6 of the viewpoint sequence Q of the switch destination to the guidepost index of the sequence Q.

After that, the information processing apparatus 10 accepts a user manipulation, and turns the page 6, a page 5, and a page 4 of the viewpoint sequence Q. Moreover, the information processing apparatus 10 accepts a user manipulation, switches to the page 4, the page 5, and the page 6, and selects a subsequent page in the state of the page 6.

Namely, the information processing apparatus 10 selects a subsequent page 24 of a task sequence S in the state in which the display index is Q6 and the guidepost index is Q6. The information processing apparatus 10 then identifies that the present sequence 16a is a general sequence, the index state is as the display index (Q6)=the guidepost index (Q6), the guidepost state 16b is temporary, and the subsequent page is generated. In other words, since the case corresponds to the seventh row in FIG. 19, the information processing apparatus 10 sets the guidepost state 16b to fixed, and adds the page indicated by the guidepost index (Q6) and the subsequent page (S24) as the history of the display history sequence P. The information processing apparatus 10 then sets the page 24 of the task sequence S of the switch destination to the guidepost index and the display index of the sequence S respectively.

As a result, the information processing apparatus 10 can store Q6 displayed when selecting the subsequent page as the history subsequent to the page 5 of the display history sequence P originally displayed, and can store the new page S24.

Fifth Specific Example

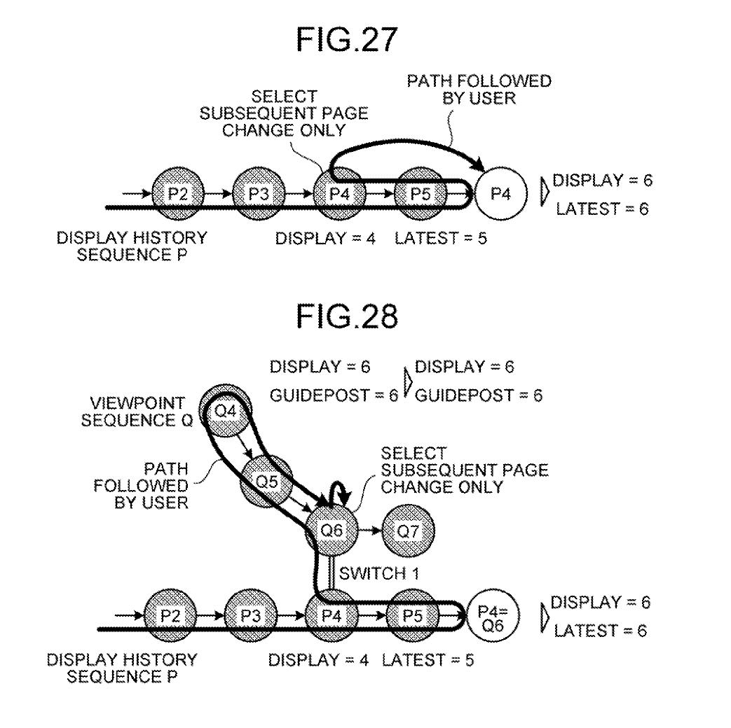

FIG. 27 is a diagram of a fifth specific example when selecting a subsequent page. As illustrated in FIG. 27, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and selects a subsequent page in the state in which the page 4 of the sequence P is displayed. In the selection, suppose that the information processing apparatus 10 displays the page 4 of the display history sequence P as it is because the corresponding subsequent page is not available.

Namely, suppose that the information processing apparatus 10 selects a subsequent page in the state in which the latest index id P5 and the display index is P4, and consequently displays the same page 4. The information processing apparatus 10 then identifies that the present sequence 16a is a display history, the index state is as the display index (P4)≠the latest index (P5), and no subsequent page is generated. In other words, since the case corresponds to the third row in FIG. 19, the information processing apparatus 10 does not set anything to the guidepost state 16b, and adds the page indicated by the display index (P4) as the history of the display history sequence P.

It is noted that the page 4 (P4) newly added corresponds to six for the index of the display history sequence P. Therefore, the information processing apparatus 10 sets the page 4 added to the history to the latest index (P6) and the display index (P6) of the sequence P. As described above, the information processing apparatus 10 can hold the page displayed when selecting a subsequent page as a display history even in a case where no subsequent page is generated.

Sixth Specific Example

FIG. 28 is a diagram of a sixth specific example when selecting a subsequent page. As illustrated in FIG. 28, the information processing apparatus 10 in turn displays a page 2, a page 3, a page 4, and a page 5 of a display history sequence P, which is a sequence first displayed, accepts a user manipulation, and turns the page to the page 4 in the state of the page 5. After that, the information processing apparatus 10 accepts a user manipulation, and performs a sequence switch 1 to a viewpoint sequence Q in the state in which the page 4 of the sequence P is displayed.

Namely, the information processing apparatus 10 switches to a page 6 of the viewpoint sequence Q in the state in which the latest index is P5 and the display index is P4. The information processing apparatus 10 then identifies that the present sequence 16a is a display history, the index state is as the display index (P4) # the latest index (P5), the guidepost state 16b is not set, and the switch destination sequence is a general sequence. In other words, since the case corresponds to the first row in FIG. 10, the information processing apparatus 10 sets the guidepost state 16b to temporary, and makes no addition to the history. The information processing apparatus 10 then sets the page 6 of the viewpoint sequence Q of the switch destination to the guidepost index.

After that, the information processing apparatus 10 accepts a user manipulation, and turns the page 6, a page 5, and a page 4 of the viewpoint sequence Q. Moreover, the information processing apparatus 10 accepts a user manipulation, switches to the page 4, the page 5, and the page 6, and selects a subsequent page in the state of the page 6. In the selection, suppose that the information processing apparatus 10 displays the page 6 of the viewpoint sequence Q as it is because the corresponding subsequent page is not available. As discussed above, even in a case where a subsequent page manipulation is made, subsequent page information is not sometimes returned depending on the content of the task.

Namely, suppose that the information processing apparatus 10 selects a subsequent page in the state in which the latest index is P5, the display index is Q6, and the guidepost index is Q6, and consequently displays the same page Q6. The information processing apparatus 10 then identifies that the present sequence 16a is a general sequence, the index state is as the display index (Q6)=the guidepost index (Q6), the guidepost state 16b is temporary, and no subsequent page is generated. In other words, since the case corresponds to the eleventh row in FIG. 19, the information processing apparatus 10 sets the guidepost state 16b to fixed, and adds the guidepost index (Q6) as the history of the display history sequence P.

It is noted that Q6 newly added corresponds to six for the index of the display history sequence P. Therefore, the information processing apparatus 10 sets Q6 added to the history to the latest index and the display index and the guidepost index. As described above, the information processing apparatus 10 can hold the page, which is displayed when making a subsequent page select manipulation and selecting a subsequent page by the user, as a display history even in a case where no subsequent page is generated.

Effect

As described above, the sequence switch has merits that the history can be browsed from various angles by page turning manipulations. Selecting a subsequent page is added to go on the task by a subsequent page select manipulation on the page in the midway point of browsing. For example, it is possible that the sequence is switched from approval work for the today's slips to the viewpoint sequence of the approval history to go on approval work for unprocessed slips. It is possible to go on the following step in which a person returns home from a business trip, submits a business trip report, goes back the viewpoint sequence including the pages of work at home, makes a reference to an e-learning page suspended in the midway point, and proceeds the e-learning from the page by a subsequent page select manipulation.

### [b] Second Embodiment

Now, the embodiment of the present invention is described so far. However, the present invention may be implemented in various different forms other than the foregoing embodiment. Therefore, in the following, a different embodiment will be described.

System

Moreover, in the processes described in the embodiment, all the processes or a part of the processes descried as automatically performed may be performed manually. Alternatively, all the processes or a part of the processes descried as manually performed may be performed automatically according to publicly known methods. Additionally, process procedures, control procedures, specific names, and information including various items of data and parameters described and illustrated in the description and the drawings can be arbitrarily changed unless otherwise specified.

Moreover, the functions of the components of the devices illustrated in the drawings are conceptual, which are not necessarily physically configured as illustrated. Namely, the specific forms of the distribution and integration of the devices are not limited to ones illustrated in the drawings. In other words, all or a part of the devices can be functionally or physically distributed and integrated in given units according to various loads or use situations, for example. Furthermore, all or a part of the process functions performed in the devices can be implemented using a CPU and a program analyzed and performed at the CPU, or can be implemented as hardware based on wired logic.

Hardware Configuration

Now, various processes described in the foregoing embodiment can be implemented by executing a program prepared beforehand on a computer system such as a personal computer or a workstation. Therefore, in the following, an exemplary computer that performs a program having the similar functions as the foregoing embodiment will be described.

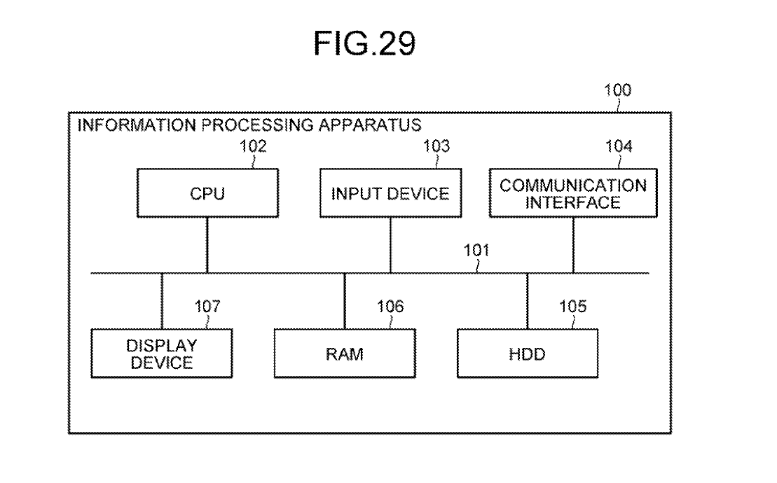

FIG. 29 is a diagram of an exemplary hardware configuration of an information processing apparatus. As illustrated in FIG. 29, an information processing apparatus 100 includes a CPU 102, an input device 103, a communication interface 104, a HDD (Hard Disk Drive) 105, a RAM (Random Access Memory) 106, and a display device 107. Moreover, the units illustrated in FIG. 29 are connected to each other through a bus 101.

The input device 103 is a mouse and a keyboard. The communication interface 104 is an interface such as an NIC (Network Interface Card). The display device 107 is a display or a touch panel on which pages are displayed with a web browser, for example. The HDD 105 stores a program that performs the functions illustrated in FIG. 1 and so on and the tables and so on described in the embodiments. The HDD 105 is taken as an example of a recording medium. Such a configuration may be possible in which various programs are stored on a computer readable recording medium such as a ROM (Read Only Memory), a RAM, and a CD-ROM and the computer is caused to read the programs. It is noted that such a configuration may be possible in which a recording medium is disposed at a remote site and the computer accesses the storage medium for acquiring and using programs. Moreover, the acquired program may be stored in a recording medium in the computer itself in making the access.

The CPU 102 reads the program that performs processing similarly to the processing units illustrated in FIG. 1 and expands the program on the RAM 106 for operating the display history control process performing the functions described in FIG. 1 and so on. Namely, this process operates the page transition managing unit 12, the page sequence holding unit 13, the viewpoint sequence managing unit 14, and the page turning control unit 16. As deceived above, the information processing apparatus 100 reads and performs the program, and operates as an information processing apparatus that performs a display history control method.

Furthermore, the information processing apparatus 100 may implement the functions similarly in the foregoing embodiments by reading a memory management program from a recording medium using a media reader and executing the read memory management program. It is noted that the program described in the other embodiments is not necessarily performed by the information processing apparatus 100. For example, the present invention can be similarly applied also in a case where a different computer or server executes the program or a different computer cooperates with a different server to execute the program.

According to an aspect of the information processing apparatus, the history control method, and the computer-readable recording medium disclosed in the present application, such effect is exerted that display histories including branches can be appropriately managed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory that stores a display history of a page displayed on a display unit for individual sequences; and
a processor coupled to the memory, wherein the processor executes a process comprising:
executing page turning in which a page displayed on the display unit is switched to a page stored in the memory and displaying the switched page on the display unit;
switching a sequence of the page displayed on the display unit and displaying a switched page on the display unit;
holding a switched second page when a sequence of a first page displayed on the display unit is switched; and
storing the held second page in the memory as a display history corresponding to the sequence of the first page, when a sequence of the second page or a sequence of a third page after switched from the second page is switched at the switching.

2. The information processing apparatus according to claim 1, wherein
the storing includes storing the second page and the third page in the memory as a display history corresponding to the sequence of the first page when the second page is different from the third page, and storing the second page in the memory as a display history corresponding to the sequence of the first page when the second page and the third page are a same page.

3. The information processing apparatus according to claim 1, wherein
the holding includes holding a third page after switched at the switching, and
the storing includes storing the third page held at the holding in the memory as a display history corresponding to the sequence of the first page, when a sequence of the third page or a sequence of a fourth page after switched from the third page is switched at the switching.

4. The information processing apparatus according to claim 1, wherein the storing includes discarding a page held at the holding in the memory when the page held at the holding is a latest display history stored in the memory.

5. The information processing apparatus according to claim 1, wherein the process further comprises displaying a subsequent page selected on a page displayed on the display unit,
wherein the storing includes storing the subsequent page displayed on the display unit at the displaying and a page on which a select to the subsequent page is accepted in the memory as a display history corresponding to the sequence of the first page.

6. The information processing apparatus according to claim 4,
wherein the storing includes storing the page on which a selection to the subsequent page is accepted in the memory as a display history corresponding to the sequence of the first page, when there is no subsequent page selected on a page displayed on the display unit.

7. A history control method comprising:
executing page turning in which page displayed on a display unit is switched to a page stored in a memory which stores the display history of a page displayed on the display unit for individual sequences, and displaying the switched page on the display unit, using a processor;
switching a sequence of the page displayed on the display unit and displaying a switched page on the display unit, using the processor;
holding a switched second page when a sequence of a first page displayed on the display unit is switched, using the processor; and
storing the held second page in the memory as a display history corresponding to the sequence of the first page, when a sequence of the second page or a sequence of a third page after switched from the second page is switched at the switching, using the processor.

8. A computer-readable recording medium having stored therein a program causing a computer to execute a history control process comprising:
executing page turning which switch a page displayed on a display unit to a page stored in a memory which stores the display history of a page displayed on the display unit for individual sequences, and displaying the switched page on the display unit;
switching a sequence of the page displayed on the display unit and displaying a switched page on the display unit;
holding a switched second page when a sequence of a first page displayed on the display unit is switched; and
storing the held second page in the memory as a display history corresponding to the sequence of the first page, when a sequence of the second page or a sequence of a third page after switched from the second page is switched at the switching.
